(19) United States
(12) Patent Application Publication
(10) Pub. No.: US 2017/0213092 A1
(43) Pub. Date: Jul. 27, 2017

(54) VIDEO GENERATION APPARATUS, VIDEO DISPLAY METHOD, AND NON-TRANSITORY COMPUTER-READABLE STORAGE MEDIUM

(71) Applicant: FUJITSU LIMITED, Kawasaki-shi (JP)

(72) Inventors: Yasushi Sugama, Yokohama (JP); Yusaku Fujii, Shinagawa (JP); Takato OHASHI, Kawasaki (JP)

(73) Assignee: FUJITSU LIMITED, Kawasaki-shi (JP)

(21) Appl. No.: 15/380,108

(22) Filed: Dec. 15, 2016

(30) Foreign Application Priority Data
Jan. 27, 2016 (JP) 2016-013821

(51) Int. Cl. G06K 9/00; B60R 1/00; H04N 7/18; G06T 7/13; G06F 3/14

(52) U.S. Cl. CPC G06K 9/00798; G06T 7/13; G06F 3/14; G06K 9/00805; G06K 9/00832; H04N 7/181; B60R 1/00; G06T 2207/30268; G06T 2207/30261; G06T 2207/30256; G06T 2207/10016; G06T 2207/20081; B60R 2300/205; B60R 2300/804; B60R 2300/302

(57) ABSTRACT

An apparatus for video generation includes: a memory; and a processor coupled to the memory and configured to execute a road surface end detection process to detect, from an image including a road surface along which a vehicle travels, a road surface end of the road surface in a widthwise direction, execute a calculation process to calculate a distance from the vehicle to the road surface end, execute a generation process to generate, when the calculated distance is smaller than a given threshold value, a video for inducing a driver of the vehicle to steer to a direction in which the distance increases, and execute a display control process to cause a display apparatus to display the generated video.

### CROSS-REFERENCE TO RELATED APPLICATION

This application is based upon and claims the benefit of priority of the prior Japanese Patent Application No. 2016-013821, filed on Jan. 27, 2016, the entire contents of which are incorporated herein by reference.

### FIELD

The present embodiments relate to a video generation apparatus, a video display method, and a non-transitory computer-readable storage medium.

### BACKGROUND

As one of technologies for inducing a driver of a vehicle to perform safe driving, there is a technology which may induce, when the traveling speed of the vehicle exceeds a given speed, the driver to slow down the vehicle.

Further, as a technology for inducing a driver of a vehicle, there is a technology which may issue an alarm when the possibility is found that the vehicle may depart from a lane along which the vehicle is traveling.

Further, as a method for presenting information for inducing a driver, a method has been and is being introduced in recent years by which information may be presented to a driver using a display device such as a head-up display unit to induce the driver to perform safe driving. In the method of the type, visual effects such as an optical illusion may be utilized to induce a driver such that the driver himself/herself naturally slows down the vehicle.

As examples of the related art, Japanese Laid-open Patent Publication No. 2015-197707 is known.

### SUMMARY

According to an aspect of the embodiments, an apparatus for video generation includes: a memory; and a processor coupled to the memory and configured to execute a road surface end detection process to detect, from an image including a road surface along which a vehicle travels, a road surface end of the road surface in a widthwise direction, execute a calculation process to calculate a distance from the vehicle to the road surface end, execute a generation process to generate, when the calculated distance is smaller than a given threshold value, a video for inducing a driver of the vehicle to steer to a direction in which the distance increases, and execute a display control process to cause a display apparatus to display the generated video.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view depicting an example of a configuration of an induction system according to a first embodiment;

FIG. 2 is a block diagram depicting a functional configuration of a video generation apparatus according to the first embodiment.

FIG. 3A is a flow chart (part 1) illustrating a video displaying process according to the first embodiment;

FIG. 3B is a flow chart (part 2) illustrating the video displaying process according to the first embodiment;

FIG. 4 is a view illustrating an example of a traveling situation of a vehicle;

FIG. 5 is a view depicting an example of a displayed video;

FIG. 6 is a view illustrating another example of a traveling situation of a vehicle;

FIG. 7A is a view (part 1) illustrating another example of a displayed video;

FIG. 7B is a view (part 2) illustrating a further example of a displayed video;

FIG. 8 is a block diagram depicting a functional configuration of a video generation apparatus according to a second embodiment;

FIG. 9A is a flow chart (part 1) illustrating a video displaying process according to the second embodiment;

FIG. 9B is a flow chart (part 2) illustrating the video displaying process according to the second embodiment;

FIG. 10 is a block diagram depicting a functional configuration of a video generation apparatus according to a third embodiment;

FIG. 11A is a flow chart (part 1) illustrating a video displaying process according to the third embodiment;

FIG. 11B is a flow chart (part 2) illustrating the video displaying process according to the third embodiment;

FIG. 11C is a flow chart (part 3) illustrating the video displaying process according to the third embodiment;

FIG. 11D is a flow chart (part 4) illustrating the video displaying process according to the third embodiment;

FIG. 12 is a view depicting an example of a video displayed by a video displaying process according to the third embodiment;

FIG. 13 is a view depicting another example of a video displayed by a video displaying process according to the third embodiment;

FIG. 14 is a block diagram depicting a functional configuration of a video generation apparatus according to a fourth embodiment;

FIG. 15 is a flow chart illustrating processes performed by a video generation apparatus according to the fourth embodiment;

FIG. 16 is a flow chart illustrating contents of a video displaying process based on driver information; and

FIG. 17 is a view depicting a hardware configuration of a computer.

### DESCRIPTION OF EMBODIMENTS

The conventional induction method that utilizes visual effects such as an optical illusion may only induce a driver to slow down the vehicle speed, but may not induce the driver to maintain, when there is the possibility that the vehicle may depart from a lane along which the vehicle is traveling, the lane. For example, the conventional method has a problem that, when there is the possibility that a vehicle may depart from a lane along which the vehicle is traveling, a more appropriate induction method may not be taken other than to issue an alarm.

As one aspect of the present embodiments, provided are solutions for being able to naturally induce, when there is the possibility that a vehicle may depart from a lane along which the vehicle is traveling, the driver to maintain the lane utilizing a sense of sight.

### First Embodiment

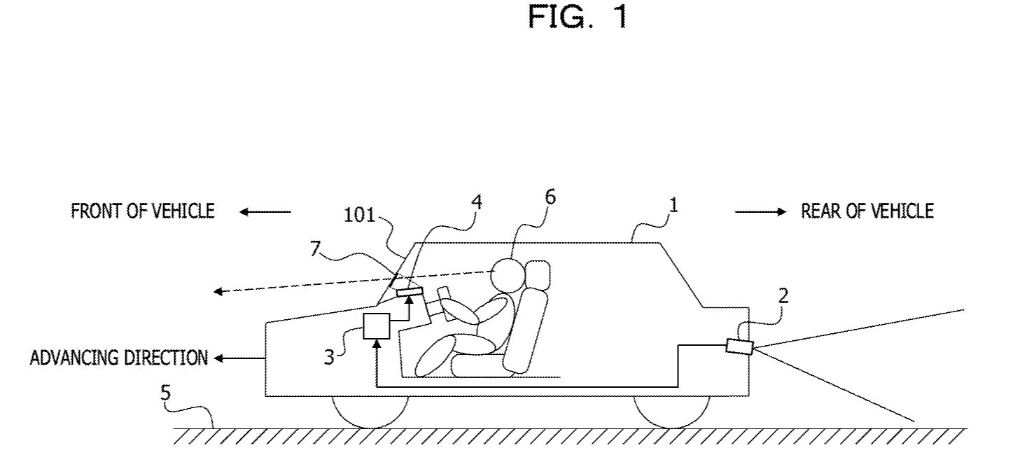

FIG. 1 is a view depicting an example of a configuration of an induction system according to a first embodiment.

As depicted in FIG. 1, the induction system according to the present embodiment includes an image pickup apparatus 2, a video generation apparatus 3, and a display apparatus 4 incorporated in a vehicle 1.

The image pickup apparatus 2 is installed at a rear portion side of a vehicle body of the vehicle 1 in such a direction that the image pickup apparatus 2 picks up an image including a road surface 5 behind the vehicle and an object on the road surface 5.

The video generation apparatus 3 generates a video that induces a driver 6 of the vehicle 1 to perform safe driving based on an image picked up by the image pickup apparatus 2. For example, the video generation apparatus 3 generates a video for inducing the driver 6 of the vehicle 1 to change the position of the vehicle 1 when the distance between the vehicle 1 and an end portion of the road surface 5 (lane) in a widthwise direction is equal to or smaller than a threshold value.

The display apparatus 4 displays a video generated by the video generation apparatus 3. The display apparatus 4 is installed in such a manner that the video generated by the video generation apparatus 3 is displayed in the field of view of the driver 6 during driving. As the display apparatus 4, for example, a head-up display (HUD) device that projects and displays a video to and on a windshield 101 or the like of the vehicle 1 is available. Where a head-up display device is used as the display apparatus 4, it may be possible to utilize a region of the windshield 101 opposing to the front face of the driver 6 as a screen 7 to present various kinds of information to the driver 6 during driving through the sense of sight.

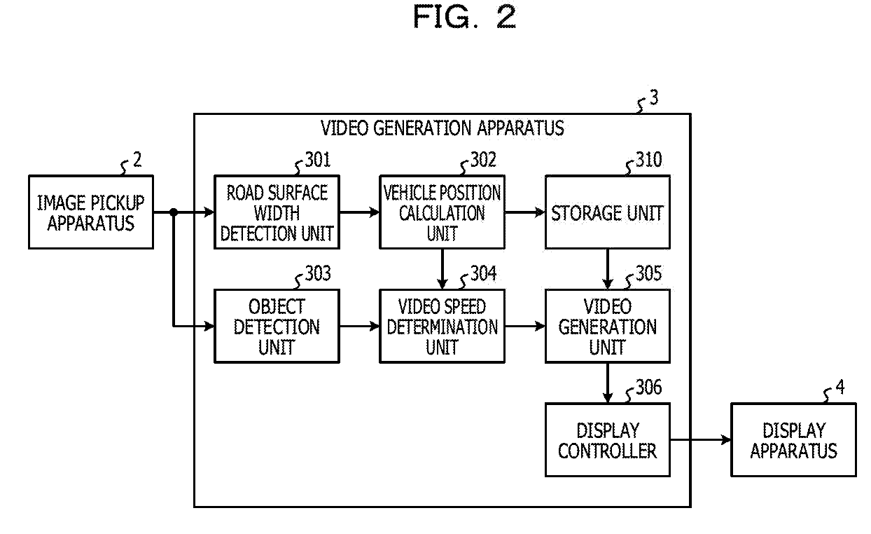

FIG. 2 is a block diagram depicting a functional configuration of a video generation apparatus according to the first embodiment.

As depicted in FIG. 2, the video generation apparatus 3 according to the present embodiment includes a road surface width detection unit 301, a vehicle position calculation unit 302, an object detection unit 303, a video speed determination unit 304, a video generation unit 305, a display controller 306, and a storage unit 310.

The road surface width detection unit 301 detects end portions of the road surface (lane) in the widthwise direction, along which the vehicle 1 is traveling, based on an image picked up by the image pickup apparatus 2.

The vehicle position calculation unit 302 calculates the position of the vehicle 1 in the widthwise direction of the lane. The vehicle position calculation unit 302 calculates, as the position of the vehicle 1, the distances from the vehicle 1 to end portions of the road surface, for example, based on the position of the end portions of the road surface in an image of the road surface.

The object detection unit 303 detects another object existing around the vehicle 1 and calculates the moving speed of the detected object. The object detection unit 303 detects, based on an image picked up by the image pickup apparatus 2, whether or not there exists an object such as another vehicle behind the vehicle 1. Further, if an object existing behind the vehicle 1 is detected, the object detection unit 303 calculates the position of the object in the widthwise direction of the road surface and a relative speed of the detected object relative to the vehicle 1.

The video speed determination unit 304 determines, based on the position of the vehicle 1 in the widthwise direction, the moving speed of a picture for induction in a video displayed on the display apparatus 4. Further, if an object existing behind the vehicle 1 is detected, the video speed determination unit 304 determines a moving speed of a picture for induction in the video displayed on the display apparatus 4 based on the position of the vehicle 1 in the widthwise direction, the position of the detected object, and the relative speed of the detected object. The picture for induction is a picture for inducing the driver 6 to perform such an operation as steering or slowing down. In the following description, the moving speed of a picture for induction is referred to as “speed” or “displaying speed.”

The video generation unit 305 generates a video including a picture for induction based on a speed determined by the video speed determination unit 304.

The display controller 306 causes the display apparatus 4 to display a video generated by the video generation unit 305.

Into the storage unit 310, data that is a source of a video including data of a picture for induction, various threshold values used in a process for generating a video and so forth are stored.

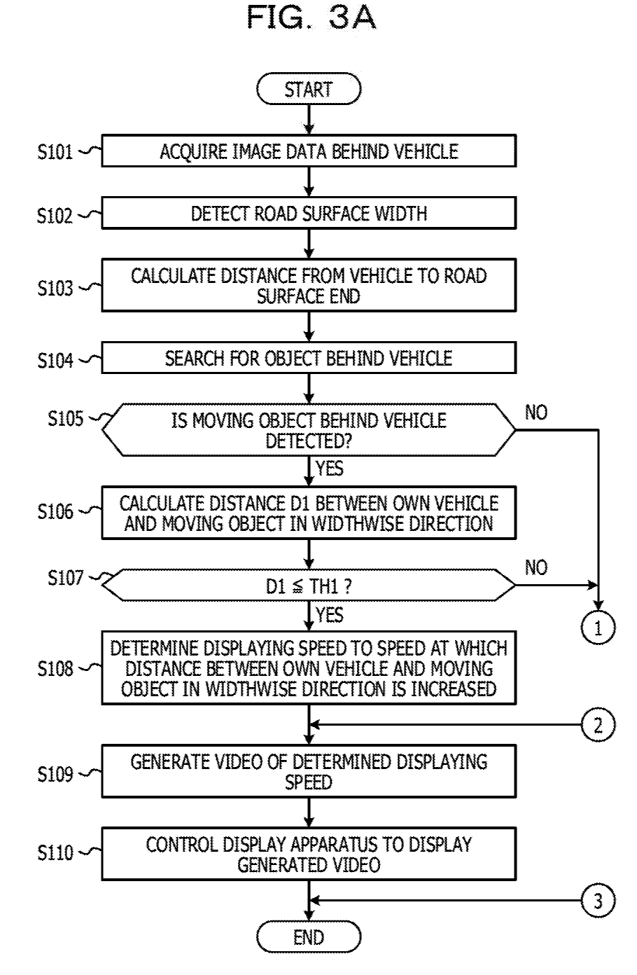

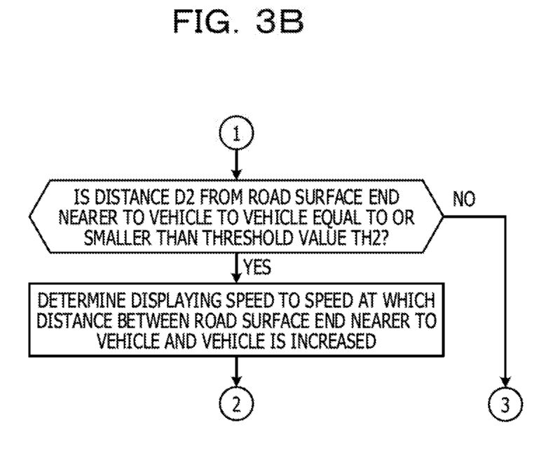

The video generation apparatus 3 in the induction system according to the present embodiment repetitively executes a video displaying process illustrated in FIGS. 3A and 3B after every given interval of time while the driver 6 is driving the vehicle 1.

FIG. 3A is a flow chart (part 1) illustrating a video displaying process according to the first embodiment. FIG. 3B is a flow chart (part 2) illustrating the video displaying process according to the first embodiment.

As illustrated in FIG. 3A, the video generation apparatus 3 of the present embodiment first acquires data of an image (hereinafter referred to also as “image data”) behind the vehicle 1 picked up by the image pickup apparatus 2 (step S101). The video generation apparatus 3 inputs the acquired image data to the road surface width detection unit 301 and the object detection unit 303.

Then, in the video generation apparatus 3, the road surface width detection unit 301 detects a road surface width of the road surface (lane) along which the vehicle 1 is traveling based on the acquired image data (step S102). The road surface width detection unit 301 extracts end portions of the road surface from the image data and detects a road surface width in accordance with a known road surface width detection method. The road surface width detection unit 301 transmits information of the detected road surface width to the vehicle position calculation unit 302.

Then, in the video generation apparatus 3, the vehicle position calculation unit 302 calculates the distance from the vehicle 1 to the road surface end (step S103). The vehicle position calculation unit 302 calculates the distance from the vehicle 1 to the road surface end based on the position of the road surface end in the image, the road surface width, and the width of the vehicle 1. At step S103, the vehicle position calculation unit 302 calculates, for example, the distance from the vehicle 1 to one of a road surface end at the left side of the vehicle 1 and another road surface end at the right side of the vehicle 1, which indicates a smaller distance from the vehicle 1. The vehicle position calculation unit 302 transmits information of the calculated distance from the vehicle 1 to the road surface end to the video speed determination unit 304.

Then, in the video generation apparatus 3, the object detection unit 303 searches for an object behind the vehicle 1 based on the image data acquired from the image pickup apparatus 2 (step S104). The object detection unit 303 searches whether or not another object exists behind the own vehicle from the image data in accordance with a known object detection method. The own vehicle is the vehicle 1 in which the image pickup apparatus 2 for picking up an image acquired by the video generation apparatus 3 is incorporated. For example, the own vehicle is the vehicle 1 that is being driven by the driver 6 who is induced using the induction system.

If the object detection unit 303 detects an object behind the vehicle 1 in the process at step S104, the object detection unit 303 calculates the position of the object in the widthwise direction and the relative speed of the detected object relative to the own vehicle. After the process at step S104 comes to an end, the object detection unit 303 transmits a result of the search to the video speed determination unit 304.

It is to be noted that the processes at steps S102 and S103 and the process at step S104 in FIG. 3A may be reverse in order. Further, the processes at step S102 and S103 and the process at step S104 may be performed in parallel.

Then, in the video generation apparatus 3, the video speed determination unit 304 decides whether or not a moving object behind the vehicle 1 is detected (step S105). The video speed determination unit 304 performs the decision at step S105 based on a result of the process at step S104 by the object detection unit 303. If a moving object is not detected behind the vehicle 1 (step S105: No), the video speed determination unit 304 subsequently performs a decision at step S111 depicted in FIG. 3B.

On the other hand, if a moving object behind the vehicle 1 is detected (step S105: Yes), the video speed determination unit 304 subsequently calculates a distance D1 between the own vehicle and the moving object in the widthwise direction (step S106). In the process at step S106, the video speed determination unit 304 calculates the distance D1 based on the position of the own vehicle in the widthwise direction and the position of the detected moving object.

Then, the video speed determination unit 304 decides whether or not the calculated distance D1 is equal to or smaller than a first threshold value TH1 (step S107). If D1>TH1 (step S107: No), the video speed determination unit 304 subsequently performs a decision at step S111 in FIG. 3B.

On the other hand, if D1≦TH1 (step S107: Yes), the video speed determination unit 304 determines the displaying speed of a picture for induction to a speed at which the distance between the own vehicle and the moving object in the widthwise direction is increased (step S108). After the process at step S108 comes to an end, the video speed determination unit 304 transmits the determined displaying speed to the video generation unit 305.

Then, in the video generation apparatus 3, the video generation unit 305 generates a video of the displaying speed determined by the video speed determination unit 304 (step S109). The video generation unit 305 reads out data that is a source of a video generated and including data of a picture for induction from the storage unit 310 and generates a video. The video generation unit 305 transmits the generated video to the display controller 306.

Finally, in the video generation apparatus 3, the display controller 306 causes the display apparatus 4 to display the video generated by the video generation unit 305 (step S110).

It is to be noted that, if a moving object is not detected behind the vehicle 1 (step S105: No), the video speed determination unit 304 subsequently performs the decision at step S111 of FIG. 3B. Further, also when the distance D1 between the own vehicle and the moving object in the widthwise direction is greater than the first threshold value TH1 (step S107: No), the video speed determination unit 304 subsequently performs the decision at step S111 in FIG. 3B. At step S111, the video speed determination unit 304 decides whether or not a distance D2 from the road surface end nearer to the vehicle 1 to the vehicle 1 is equal to or smaller than a second threshold value TH2. If D2>TH2 (step S111: No), the video speed determination unit 304 decides that a video for inducing the driver 6 is not to be displayed. In this case, the video generation apparatus 3 ends the video displaying process omitting the processes at steps S108 and S109 as illustrated in FIG. 3A and starts a next video displaying process.

On the other hand, if D2≦TH2 (step S111: Yes), the video speed determination unit 304 determines the displaying speed to a speed at which the distance D2 between the road surface end nearer to the vehicle 1 and the vehicle 1 is increased (step S112). After the process at step S112 comes to an end, the video speed determination unit 304 transmits the determined displaying speed to the video generation unit 305. In this case, after performing the processes at steps S108 and S109 as illustrated in FIG. 3A, the video generation apparatus 3 starts a next video displaying process.

In this manner, in the video displaying process according to the present embodiment, when the distance between a moving object existing behind the own vehicle and the own vehicle in the widthwise direction is equal to or smaller than the first threshold value and when the distance between the own vehicle and a road surface end is equal to or smaller than the second threshold value, a video for inducing the driver 6 is displayed.

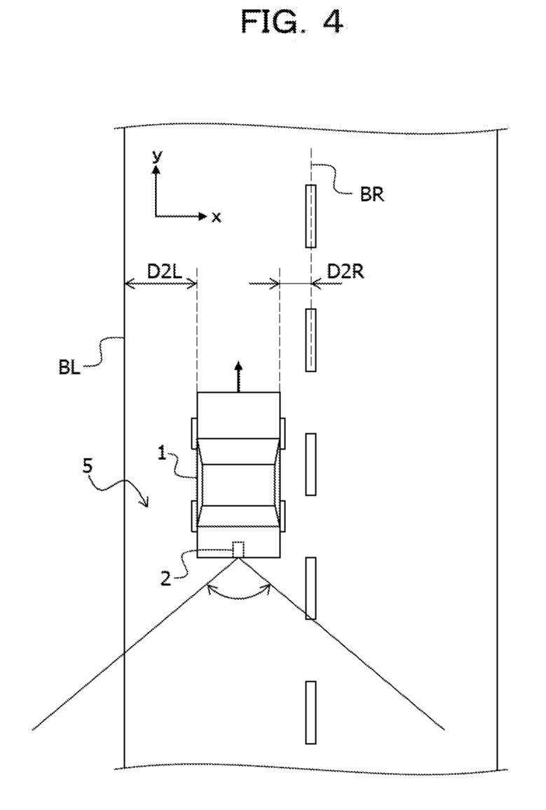

FIG. 4 is a view illustrating an example of a traveling situation of a vehicle. In FIG. 4, a view when the vehicle 1 that travels along a road surface 5 having one lane is viewed from above is depicted. Further, in FIG. 4, the leftward and rightward direction of the vehicle body of the vehicle 1 is represented as x direction and the direction from the left end toward the right end of the vehicle body is represented as +x direction. Further, in FIG. 4, the forward and rearward direction of the vehicle body of the vehicle 1 is represented as y direction and the direction from the rear end toward the front end of the vehicle body is represented as +y direction. Further, the advancing direction of the vehicle 1 is represented as +y direction.

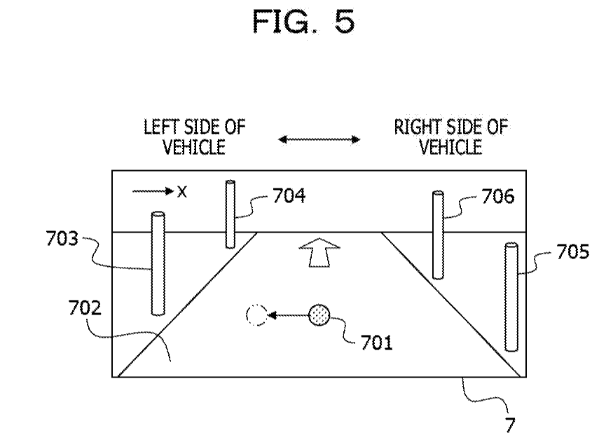

In the example illustrated in FIG. 4, the video generation apparatus 3 (not depicted) incorporated in the vehicle 1 is performing the video displaying process described hereinabove based on image data picked up by the image pickup apparatus 2 installed at a rear end portion of the vehicle body. At this time, the video generation apparatus 3 calculates distances D2R and D2L from the vehicle 1 to road surface ends BR and BL in the widthwise direction (x direction) of the road surface 5. Here, if it is assumed that the position of the vehicle 1 in the widthwise direction is nearer to the road surface right end BR side with respect to the center of the road surface, the vehicle position calculation unit 302 of the video generation apparatus 3 calculates the distance D2R from the vehicle 1 to the road surface right end BR. Therefore, if a moving object approaching the vehicle 1 from the rear is not detected (step S105: No), the video speed determination unit 304 of the video generation apparatus 3 decides whether or not the distance D2R from the vehicle 1 to the road surface right end BR is equal to or smaller than the second threshold value TH2 (step S111). The second threshold value TH2 has an arbitrary positive value and is set, for example, to a distance with which contact of the own vehicle 1 with a structure neighboring with the road surface (lane) or with another vehicle traveling along a neighboring lane or the like may be avoidable. For example, if the distance D2R from the vehicle 1 to the road surface right end BR has a relationship of D2R≦TH2 (step S111: Yes), there is the possibility that the vehicle 1 may depart from the lane and be brought into contact with another vehicle that is traveling along the opposite lane at the right side. Accordingly, when the distance D2R from the vehicle 1 to the road surface right end BR has the relationship of D2R≦TH2 (step S111: Yes), the video generation apparatus 3 generates a video for inducing the driver 6 of the vehicle 1 to increase the distance D2R from the vehicle 1 to the road surface right end BR and causes the display apparatus 4 to display the video. In this case, the video generation apparatus 3 generates, for example, such a video 7 as depicted in FIG. 5 and causes the display apparatus 4 to display the video 7. FIG. 5 is a view depicting an example of a displayed video.

Where the distance D2R from the vehicle 1 to the road surface right end BR is equal to or smaller than the second threshold value TH2, the driver 6 is induced to steer the vehicle 1 to move leftwardly. In this case, a video in which a picture 701 for induction in the video 7 moves leftwardly is displayed on the display apparatus 4.

In the video 7, also a picture 702 representative of the road surface 5 on which the vehicle 1 is traveling is displayed. The picture 702 representative of the road surface 5 is displayed such that the width of the road surface 5 at the farther side in the advancing direction is narrower than the width at the nearer side in the advancing direction or an arrow mark indicative of the advancing direction is displayed to clearly indicate the advancing direction. Further, in the video 7, for example, columnar objects 703 to 706 or the like may be displayed on the left side and the right side of the picture 702 representative of the road surface 5.

The driver 6 who watches a video of an object that moves in the widthwise direction orthogonal to the advancing direction (for example, an object having a speed in the widthwise direction) comes to have a visual-induced self-motion sensation (vection), for example, a sensation that the vehicle 1 is slipping in the widthwise direction. If a vection occurs, the driver 6 tends to steer the vehicle 1 in a direction in which the vection is cancelled. For example, if the driver 6 watches a video in which the picture 701 for induction moves in the leftward direction as depicted in FIG. 5, the driver 6 tends to steer the vehicle 1 in a direction in which the speed sensation in the widthwise direction is cancelled, namely, in the leftward direction. Therefore, where the distance D2R from the vehicle 1 to the road surface right end BR is equal to or smaller than the second threshold value TH2, such a video in which the picture 701 for induction moves in the leftward direction as depicted in FIG. 5 is displayed, consequently, it may be possible to induce the driver 6 to steer.

Further, although detailed description is omitted, where the distance D2L from the vehicle 1 to the road surface left end BL is equal to or smaller than the second threshold value TH2, a video in which the picture 701 for induction moves in the rightward direction reverse to that in FIG. 5 is displayed. Consequently, it may be possible to induce the driver 6 to steer such that the distance D2L from the vehicle 1 to the road surface left end BL may increase.

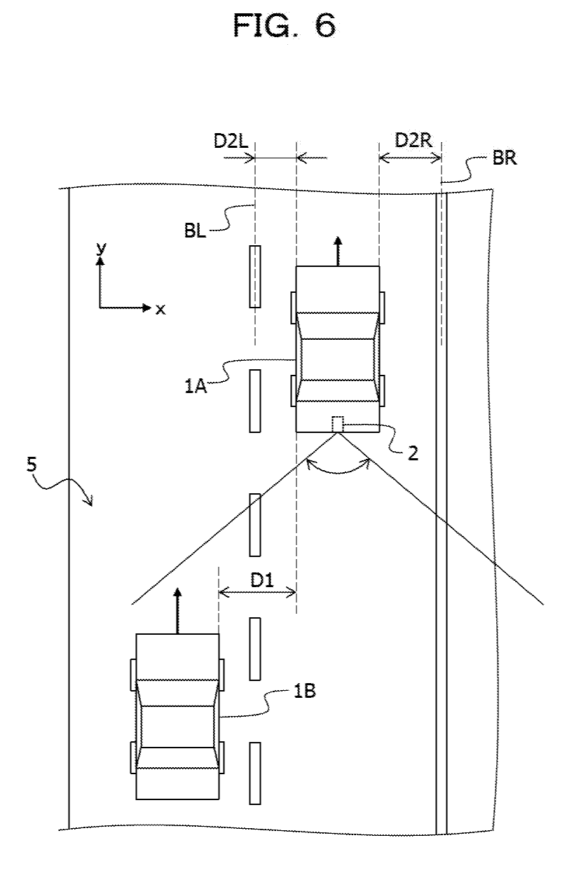

FIG. 6 is a view illustrating another example of a traveling situation of a vehicle. FIG. 6 depicts a view when an own vehicle 1A and another vehicle 1B traveling on a road surface 5 having two lanes each are viewed from above. Further, in FIG. 6, the leftward and rightward direction of the vehicle body of the vehicles 1A and 1B is represented as x direction and the direction from the left end toward the right end of the vehicle body is represented as +x direction. Further, in FIG. 6, the forward and rearward direction of the vehicle body of the vehicles 1A and 1B is represented as y direction and the direction from the rear end toward the front end of the vehicle body is represented as +y direction. Further, the advancing direction of the vehicles 1A and 1B is represented as +y direction.

In the example depicted in FIG. 6, the video generation apparatus 3 (not depicted) incorporated in the own vehicle 1A performs the video displaying process described hereinabove based on image data picked up by the image pickup apparatus 2 installed at a rear end portion of the vehicle body. At this time, the video generation apparatus 3 calculates the distances D2R and D2L from the vehicle 1 to the road surface ends BR and BL in the widthwise direction (x direction) of the road surface 5. Here, if it is assumed that the position of the vehicle 1 in the widthwise direction is nearer to the road surface left end BL side with respect to the center of the road surface, the vehicle position calculation unit 302 of the video generation apparatus 3 calculates the distance D2L from the vehicle 1 to the road surface left end BL.

Further, if detecting based on image data that the other vehicle 1B existing behind the own vehicle 1A is approaching the own vehicle 1A, the video generation apparatus 3 calculates the distance D1 from the own vehicle 1A to the other vehicle 1B in the widthwise direction (step S106).

Then, the video generation apparatus 3 of the vehicle 1 decides whether or not the distance D1 from the own vehicle 1A to the other vehicle 1B in the widthwise direction is equal to or smaller than the first threshold value TH1 (step S107). If D1≦TH1 (step S107: Yes), there is the possibility that the other vehicle 1B approaching from the rear may contact with the own vehicle 1A. Accordingly, the video generation apparatus 3 generates a video for inducing the driver 6 to steer the vehicle 1 rightwardly and causes the display apparatus 4 to display the video. In this case, the video generation apparatus 3 generates, for example, a video in which the picture 701 for induction depicted in FIG. 5 moves in the rightward direction and causes the display apparatus 4 to display the video. The driver 6 watching the video in which the picture 701 for induction moves in the rightward direction tends to steer the own vehicle 1A in the rightward direction in order to cancel the sensation (vection) that the own vehicle 1A is slipping in the leftward direction. Therefore, it may be possible to induce the driver 6 to steer to avoid a contact or the like with the other vehicle 1B approaching from the rear.

On the other hand, if the distance D1 from the own vehicle 1A to the other vehicle 1B is greater than the first threshold value TH1 (step S107: No), the video generation apparatus 3 decides whether or not the distance D2 from the own vehicle 1A to the road surface end is equal to or smaller than the second threshold value TH2 (step S111). In the example depicted in FIG. 6, the video generation apparatus 3 decides whether or not the distance D2L from the own vehicle 1A to the road surface left end BL is equal to or smaller than the second threshold value TH2. If D2L>TH2 (step S111: No), the video generation apparatus 3 decides that a sufficient distance exists from the own vehicle 1A to the road surface left end BL and does not generate a video for inducing the driver 6 to steer. Therefore, the display apparatus 4 does not display a video that induces the driver 6 to steer. In contrast, if D2L≦TH2 (step S111: Yes), the video generation apparatus 3 decides that the own vehicle 1A comes excessively near to the road surface left end BL and there is the possibility that the own vehicle 1A may contact with the other vehicle 1B traveling on the lane at the left side or the like. Therefore, when D2L≦TH2 (step S111: Yes), the video generation apparatus 3 generates, for example, a video in which the picture 701 for induction depicted in FIG. 5 moves in the rightward direction and causes the display apparatus 4 to display the video. Consequently, it may be possible to induce the driver 6 to steer and avoid such a situation that the own vehicle 1A departs from its lane and comes to contact with the other vehicle 1B traveling on the lane at the left side or the like.

It is to be noted that the video 7 depicted in FIG. 5 is a mere example of a video for inducing the driver 6 to steer and also it may be possible to induce the driver 6 to steer using another video.

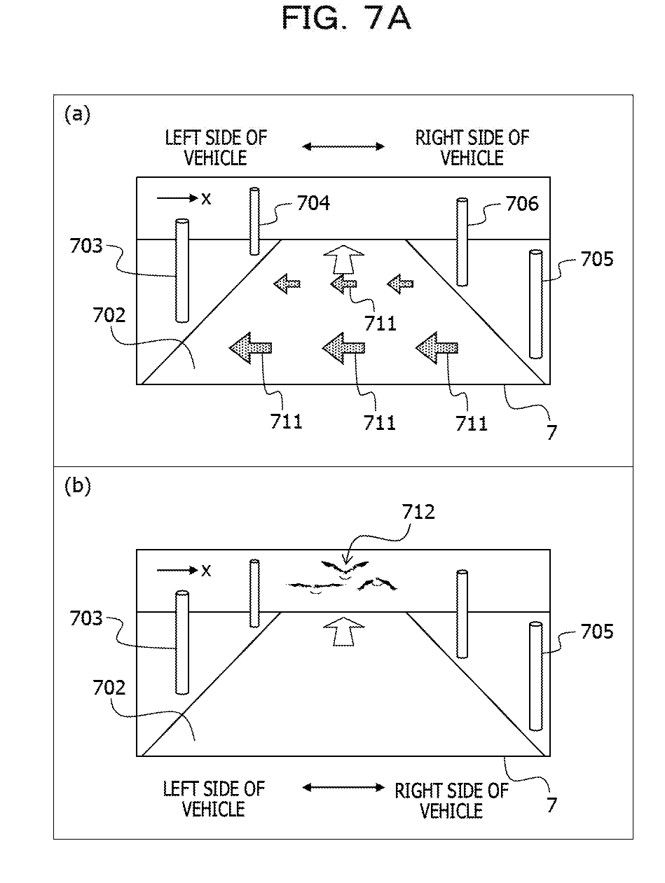

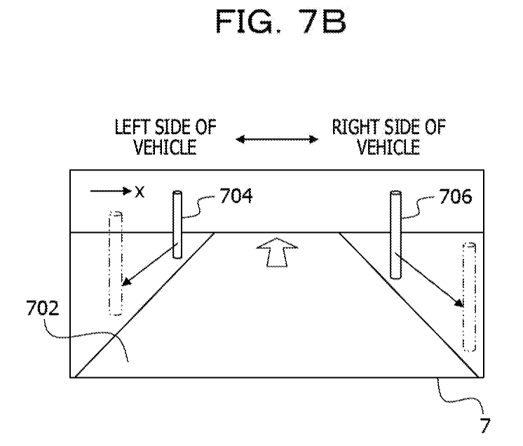

FIG. 7A is a view (part 1) illustrating another example of a displayed video. FIG. 7B is a view (part 2) illustrating a further example of a displayed video.

In the video displaying process according to the present embodiment, a video is generated and displayed which is able to induce the driver 6 to steer such that the distance from the vehicle 1 (own vehicle 1A) to a road surface end or the other vehicle 1B may increase. Along with this, the picture for inducing the driver 6 may be such a circular picture 701 as depicted in FIG. 5 and a picture 711 of an arrow mark shape as depicted in (a) of FIG. 7A, for example. Where the driver 6 is induced by the picture 711 of an arrow mark shape, for example, the direction to which the driver 6 is induced is indicated by a direction of an arrow mark.

Alternatively, the picture for inducing the driver 6 may be a picture of an animal such as a picture 712 of a bird depicted in (b) of FIG. 7A. Where the driver 6 is induced by the picture 712 of a bird, for example, the video 7 in which the picture 712 of a bird moves in a direction opposite to the direction in which the driver 6 is induced is generated and displayed similarly to the picture 701 of a circle.

Further, in the video displaying process according to the present embodiment, for example, such a video 7 as depicted in FIG. 7B may always be displayed and switched, when such a situation that it is desirable to induce the driver 6 occurs, to a video in which a picture 701 of a circle or the like is additionally displayed. In this case, in the video 7 that may always be displayed, the columnar objects 704 and 706 or the like displayed on the left side and the right side of the picture 702 representative of the road surface 5 may be moved in the opposite direction to the advancing direction.

As described above, according to the present embodiment, when the distance between a vehicle and a road surface end is excessively small, it may be possible to utilize a video to induce the driver of the vehicle to steer such that the distance between the vehicle and the road surface end increases. Therefore, where there is the possibility that the vehicle may depart from the lane along which the vehicle is traveling, it may be possible to utilize the sense of sight to induce the driver to steer so as to maintain the lane.

Further, according to the present embodiment, also where the distance between an own vehicle and another vehicle that approaches the own vehicle from the rear in the widthwise direction is excessively small, it may be possible to induce the driver of the own vehicle to steer so as to increase the distance between the own vehicle and the other vehicle in the widthwise direction.

Further, since a video that causes the driver to have a vection is displayed to induce the driver to steer as described above, it may be possible to induce the driver to naturally perform steering in comparison with an alternative case in which alarming sound is used for induction. Further, since it is possible to induce the driver without generating alarming sound, it may be possible to induce the driver without giving a discomfort to the driver or another passenger.

It is to be noted that, in the video generation apparatus 3 according to the present embodiment, a moving object behind the vehicle is detected based on image data acquired from the single image pickup apparatus 2. However, the video generation apparatus 3 is not limited to this and may use a radar apparatus or the like different from the image pickup apparatus 2 to detect a moving object behind the vehicle, for example. Further, the video generation apparatus 3, for example, may include, in addition to the image pickup apparatus 2 or the radar apparatus, an image pickup apparatus for picking up an image including the road surface in front of the vehicle and may detect a road surface end from an image including the road surface in front of the vehicle.

### Second Embodiment

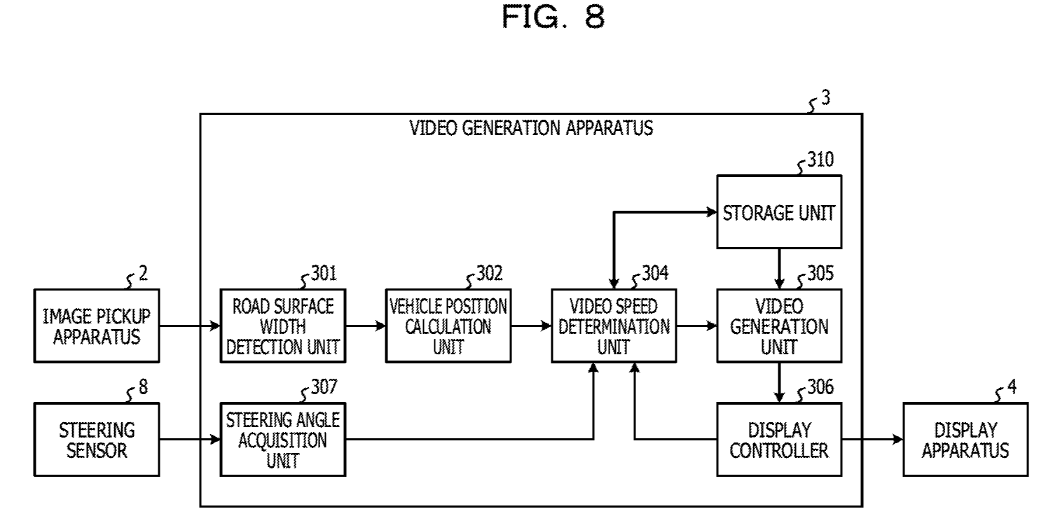

FIG. 8 is a view depicting a functional configuration of a video generation apparatus according to a second embodiment.

The video generation apparatus 3 according to the present embodiment is incorporated as a component of an induction system in a vehicle 1 similarly to the video generation apparatus 3 according to the first embodiment.

As depicted in FIG. 8, the video generation apparatus 3 according to the present embodiment includes a road surface width detection unit 301, a vehicle position calculation unit 302, a video speed determination unit 304, a video generation unit 305, a display controller 306, a steering angle acquisition unit 307, and a storage unit 310.

The road surface width detection unit 301 and the vehicle position calculation unit 302 are same as the road surface width detection unit 301 and the vehicle position calculation unit 302 in the first embodiment. The video generation unit 305 and the display controller 306 are same as the video generation unit 305 and the display controller 306 in the first embodiment.

The video speed determination unit 304 determines a moving speed (displaying speed) for a picture for induction in a video displayed on the display apparatus 4 based on the position of the vehicle 1 in the widthwise direction and the steering angle. The video speed determination unit 304 acquires the position of the vehicle 1 in the widthwise direction from the vehicle position calculation unit 302 and acquires the steering angle from the steering angle acquisition unit 307. It is to be noted that the video speed determination unit 304 in the present embodiment determines a speed of a picture for induction in a video displayed on the display apparatus 4 when the distance D2 between a road surface end nearer from the vehicle 1 and the vehicle 1 is equal to or smaller than a threshold value TH2 and the steering angle is smaller than a threshold value TH3. Further, the video speed determination unit 304 corrects the speed of a picture for induction based on a variation amount between steering angles before and after the display controller 306 causes the display apparatus 4 to display a video including a picture for induction. The video speed determination unit 304 acquires the steering angle from the steering angle acquisition unit 307 and calculates a variation amount between the steering angles before and after a video including a picture for induction is displayed on the display apparatus 4.

The steering angle acquisition unit 307 acquires information relating to a turn angle (steering angle) of a steering wheel of the vehicle 1, from a steering sensor 8 incorporated in the vehicle 1.

Into the storage unit 310, data that is a source of a video generated and including data of a picture for induction, information of the steering angle when a speed of a picture for induction is determined and so forth are stored.

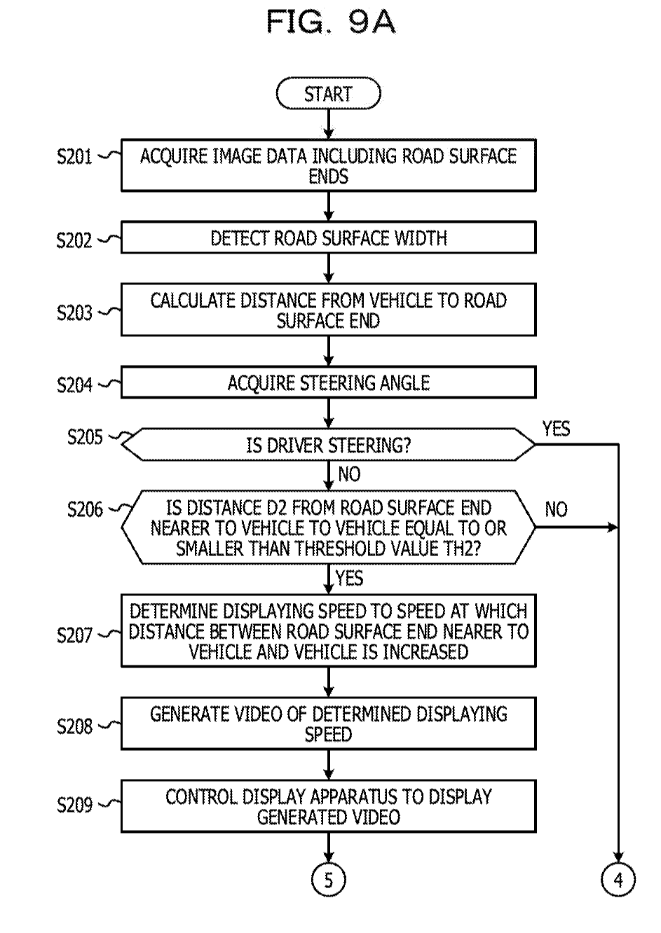

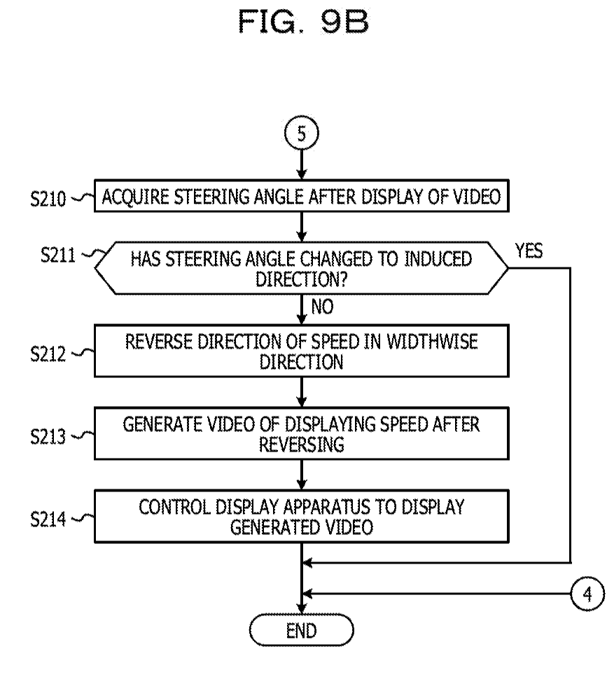

The video generation apparatus 3 according to the present embodiment repetitively executes the video displaying process illustrated in FIGS. 9A and 9B after every given interval of time while the driver 6 is driving the vehicle 1.

FIG. 9A is a flow chart (part 1) illustrating a video displaying process according to the second embodiment. FIG. 9B is a flow chart (part 2) illustrating the video displaying process according to the second embodiment.

As illustrated in FIG. 9A, the video generation apparatus 3 of the present embodiment first acquires data of an image including road surface ends from the image pickup apparatus 2 (step S201). The video generation apparatus 3 inputs the acquired image data to the road surface width detection unit 301.

Then, in the video generation apparatus 3, the road surface width detection unit 301 detects the road surface width of the road surface (lane) along which the vehicle 1 is traveling based on the acquired image data (step S202). The road surface width detection unit 301 extracts the end portions of the road surface from the image data in accordance with a known road surface width detection method to detect the road surface width. The road surface width detection unit 301 transmits information relating to the detected road surface width to the vehicle position calculation unit 302.

Then, in the video generation apparatus 3, the vehicle position calculation unit 302 calculates the distance from the vehicle 1 to a road surface end (step S203). The vehicle position calculation unit 302 calculates the distance from the vehicle 1 to a road surface end based on the position of the road surface end in the image, the road surface width, and the width of the vehicle 1. At step S203, the vehicle position calculation unit 302 calculates, for example, the distance from the vehicle 1 to one of a road surface end at the left side of the vehicle 1 and another road surface end at the right side of the vehicle 1, which indicates a smaller distance from the vehicle 1. The vehicle position calculation unit 302 transmits information relating to the calculated distance from the vehicle 1 to the road surface end to the video speed determination unit 304.

Then, in the video generation apparatus 3, the steering angle acquisition unit 307 acquires a steering angle at present of the vehicle 1 (step S204). The steering angle acquisition unit 307 acquires information of the turn angle (steering angle) of the steering wheel at present from the steering sensor 8 incorporated in the vehicle 1. It is to be noted that the steering angle when the turn angle of the steering wheel is zero degrees, for example, when the vehicle 1 advances straightforwardly, is determined as zero degrees and the steering angle when the steering wheel is rotated in the clockwise direction as viewed from the driver 6 is determined to have a positive value. The steering angle acquisition unit 307 transmits information of the acquired steering angle to the video speed determination unit 304.

It is to be noted that the processes at steps S201 to S203 and the process at step S204 may be reversed in order. Alternatively, the processes at steps S201 to S203 and the process at step S204 may be performed in parallel.

Then, in the video generation apparatus 3, the video speed determination unit 304 decides whether or not the driver 6 is steering (step S205). At step S205, the video speed determination unit 304 performs a decision regarding whether or not the direction of the steering angle is a direction in which the vehicle 1 is moved in a direction toward a nearer road surface end from the vehicle 1 and another decision regarding whether or not the absolute value of the steering angle is equal to or higher than the threshold value TH3. If the direction of the steering angle is a direction in which the vehicle 1 is moved in a direction toward a nearer road surface end from the vehicle 1 and besides the absolute value of the steering angle is equal to or higher than the threshold value TH3, the video speed determination unit 304 decides that the driver 6 is steering with an intention to change the lane or the like. If the driver 6 is steering (step S205: Yes), the video speed determination unit 304 decides that a video for inducing the driver 6 is not to be displayed. In this case, the video generation apparatus 3 ends the video displaying process as depicted in FIG. 9B and starts a next video displaying process.

On the other hand, if the driver 6 is not steering (step S205: No), the video speed determination unit 304 subsequently decides whether or not the distance D2 from the road surface end nearer to the vehicle 1 to the vehicle 1 is equal to or smaller than the threshold value TH2 (step S206). If D2>TH2 (step S206: No), the video speed determination unit 304 decides that a video for inducing the driver 6 is not to be displayed. In this case, the video generation apparatus 3 ends the video displaying process as depicted in FIG. 9B and starts a next video displaying process.

On the other hand, if D2≦TH2 (step S206: Yes), the video speed determination unit 304 determines the displaying speed (moving speed) of a picture for induction to a speed at which the distance D2 between the road surface end nearer to the vehicle 1 and the vehicle 1 is increased (step S207). After the process at step S207 comes to an end, the video speed determination unit 304 transmits the determined displaying speed to the video generation unit 305. Further, the video speed determination unit 304 stores the steering angle at present into the storage unit 310.

Then, in the video generation apparatus 3, the video generation unit 305 generates a video of the displaying speed determined by the video speed determination unit 304 (step S208). The video generation unit 305 reads out data that is a source of a video generated and including data of a picture for induction from the storage unit 310 to generate a video. The video generation unit 305 transmits the generated video to the display controller 306.

Then, in the video generation apparatus 3, the display controller 306 causes the display apparatus 4 to display the video generated by the video generation unit 305 (step S209). At this time, the display controller 306 notifies the video speed determination unit 304 that the video is displayed on the display apparatus 4.

Then, the video speed determination unit 304 of the video generation apparatus 3 acquires a steering angle after the display of the video through the steering angle acquisition unit 307 as depicted in FIG. 9B (step S210) and decides whether or not the steering angle has changed to the induced direction (step S211). At step S211, the video speed determination unit 304 reads out the steering angle before the display of the video from the storage unit 310 and compares the read out steering angle with the steering angle after the display of the video to decide whether or not the steering angle has changed to the induced direction. If the steering angle has changed to the induced direction (step S211: Yes), the video speed determination unit 304 decides that the speed of a picture for induction is not to be corrected. In this case, the video generation apparatus 3 ends the video displaying process omitting the processes at steps S212 to S214 as depicted in FIG. 9B and starts a next video displaying process.

On the other hand, if the steering angle has not changed to the induced direction (step S211: No), the video speed determination unit 304 performs correction for reversing the direction of the displaying speed of a picture for induction (step S212). For example, after the video for inducing the driver 6 to steer is displayed, if the steering angle does not change to the induced direction, the video speed determination unit 304 reverses the moving direction for a picture for induction. The video speed determination unit 304 transmits the reversed displaying speed to the video generation unit 305.

Then, in the video generation apparatus 3, the video generation unit 305 generates a video in which the displaying speed of a picture for induction is reversed (step S213). The video generation unit 305 transmits the generated video to the display controller 306.

Finally, in the video generation apparatus 3, the display controller 306 causes the display apparatus 4 to display the video generated by the video generation unit 305 (step S214).

In this manner, in the video displaying process according to the present embodiment, when the distance D2 between a road surface end nearer from the vehicle 1 and the vehicle 1 is equal to or smaller than the threshold value TH2, a video that induces the driver 6 to steer so as to increase the distance D2 is generated and displayed on the display apparatus 4. At this time, the video generation apparatus 3 first displays, at steps S207 to S209, a picture for induction that moves toward a farther one of the road surface ends from the vehicle 1. For example, where the vehicle 1 is located rather near to the road surface right end BR as depicted in FIG. 4, the video generation apparatus 3 generates a video including a picture 701 for induction that moves to the left side from the center in the leftward and rightward direction of the video 7 as depicted in FIG. 5 and causes the display apparatus 4 to display the video 7. The driver 6 watching such a video tends to have a vection that the vehicle 1 is moving (slipping) rightwardly as described in connection with the first embodiment.

However, when a video including the picture 701 for induction that moves to the left side from the center in the leftward and rightward direction of the video 7 is displayed, depending upon the driver 6, a vection that the vehicle 1 is moving (slipping) leftwardly may occur. Therefore, when a video for inducing the driver 6 to move the vehicle 1 leftwardly is displayed, there is the possibility that the driver 6 may steer rightwardly in the opposite direction to the induced direction. Therefore, in the video displaying process according to the present embodiment, after a picture for induction that moves toward a farther one of the road surface ends from the vehicle 1 is displayed at steps S207 to S209, it is decided whether or not the driver 6 is induced correctly at steps S210 and S211. Then, if the driver 6 is induced to the wrong direction (step S211: No), the video generation apparatus 3 reverses the moving speed (moving direction) for a picture for induction in the widthwise direction. For example, when a video in which the picture 701 for induction moves to the left side in order to induce the driver 6 to move the vehicle 1 leftwardly is displayed, if the driver 6 steers rightwardly in the opposite direction to the induced direction, the video generation apparatus 3 corrects the displayed video to a video in which the picture 701 for induction moves to the right side. This makes it possible to induce the driver 6 to steer such that the vehicle 1 moves leftwardly.

It is to be noted that the processes illustrated in FIGS. 9A and 9B are a mere example of the video displaying process according to the present embodiment. The video displaying process according to the present embodiment may be a process that includes a process for displaying a video for inducing a driver to steer based on the distance between a moving object (another vehicle), which approaches an own vehicle from the rear and the own vehicle as in the first embodiment. Where a process for displaying a video for inducing a driver to steer based on the distance between a moving object (another vehicle) approaching the own vehicle from the rear and the own vehicle as in the first embodiment is involved, the video generation apparatus 3 includes an object detection unit 303.

### Third Embodiment

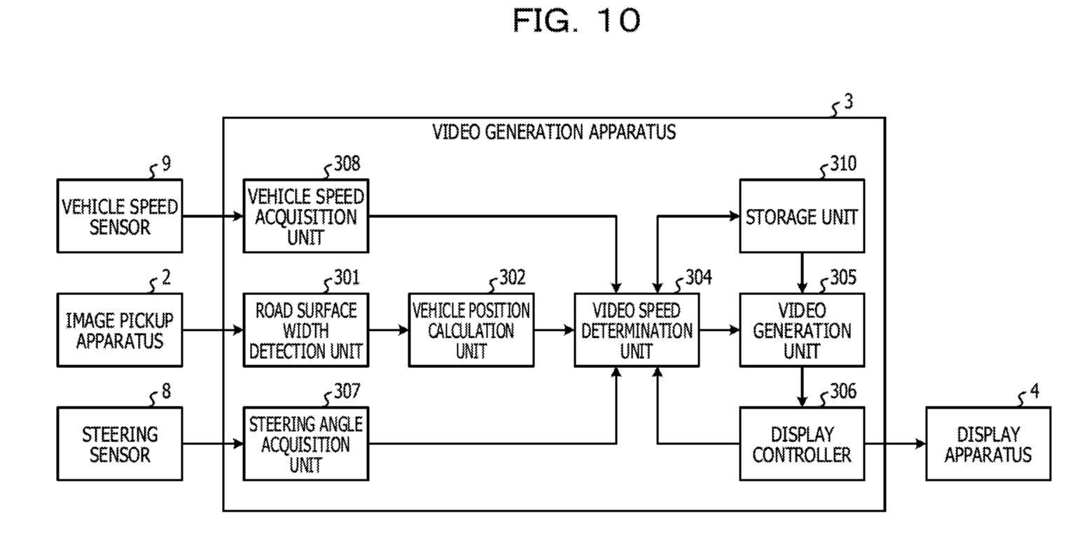

FIG. 10 is a block diagram depicting a functional configuration of a video generation apparatus according to a third embodiment.

The video generation apparatus 3 according to the present embodiment is incorporated as a component of an induction system in a vehicle 1 similarly to the video generation apparatus 3 according to the first embodiment.

As depicted in FIG. 10, the video generation apparatus 3 according to the present embodiment includes a road surface width detection unit 301, a vehicle position calculation unit 302, a video speed determination unit 304, a video generation unit 305, a display controller 306, a steering angle acquisition unit 307, a vehicle speed acquisition unit 308, and a storage unit 310.

The road surface width detection unit 301 and the vehicle position calculation unit 302 are same as the road surface width detection unit 301 and the vehicle position calculation unit 302 in the first embodiment. The video generation unit 305 and the display controller 306 are same as the video generation unit 305 and the display controller 306 in the first embodiment.

The video speed determination unit 304 determines a moving speed (displaying speed) for a picture for induction in a video displayed on the display apparatus 4 based on the position of the vehicle 1 in the widthwise direction, the steering angle, and the speed (vehicle speed) of the vehicle 1. The video speed determination unit 304 acquires the position of the vehicle 1 in the widthwise direction from the vehicle position calculation unit 302 and acquires the steering angle from the steering angle acquisition unit 307. Further, the video speed determination unit 304 acquires the vehicle speed from the vehicle speed acquisition unit 308. It is to be noted that the video speed determination unit 304 in the present embodiment determines a speed of a picture for induction in a video displayed on the display apparatus 4 when a distance D2 between the road surface end nearer from the vehicle 1 and the vehicle 1 is equal to or smaller than a threshold value TH2 and besides the steering angle is smaller than a threshold value TH3. When a speed of a picture for induction is determined, the video speed determination unit 304 determines a speed of a picture for induction in the widthwise direction based on the position of the vehicle 1 in the widthwise direction and determines a speed of a picture for induction in the advancing direction based on the vehicle speed. Further, the video speed determination unit 304 corrects the speed of the picture for induction based on a variation amount between the steering angles before and after the display controller 306 causes the display apparatus 4 to display a video including a picture for induction.

The steering angle acquisition unit 307 acquires information relating to the steering angle, for example, the turn angle of the steering wheel of the vehicle 1, from a steering sensor 8 incorporated in the vehicle 1.

The vehicle speed acquisition unit 308 acquires speed information of the vehicle 1 from a vehicle speed sensor 9 incorporated in the vehicle 1.

Into the storage unit 310, data that is a source of a video generated and including data of a picture for induction, information of the steering angle when a speed of a picture for induction is determined and so forth are stored.

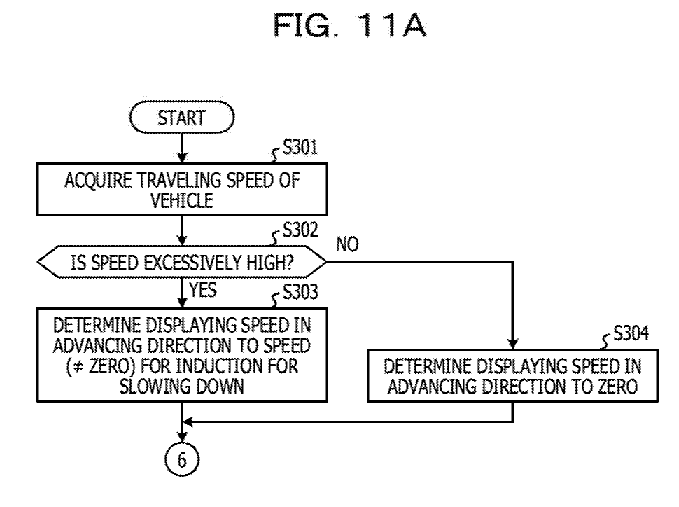

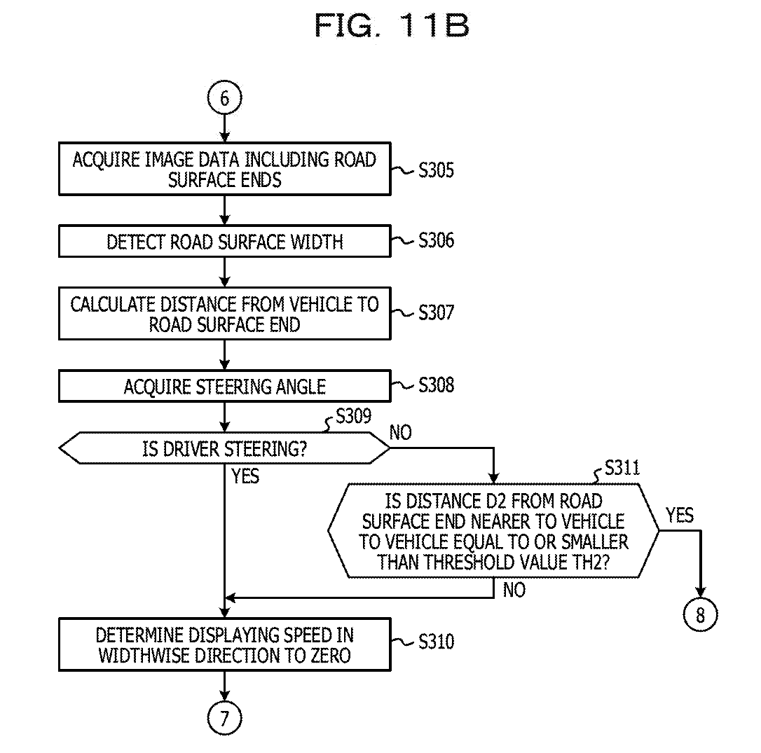

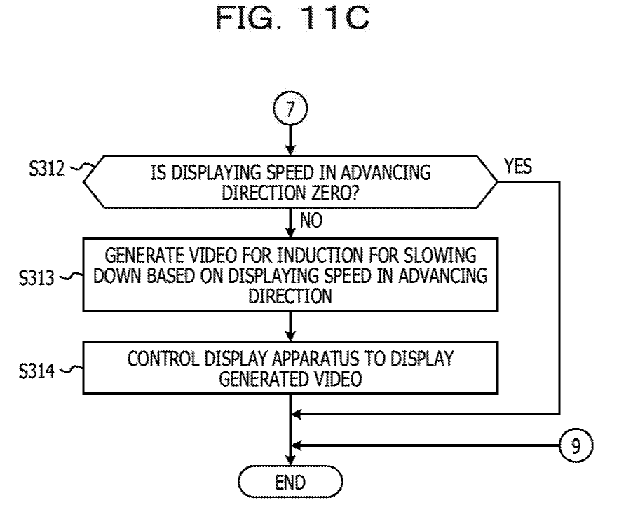

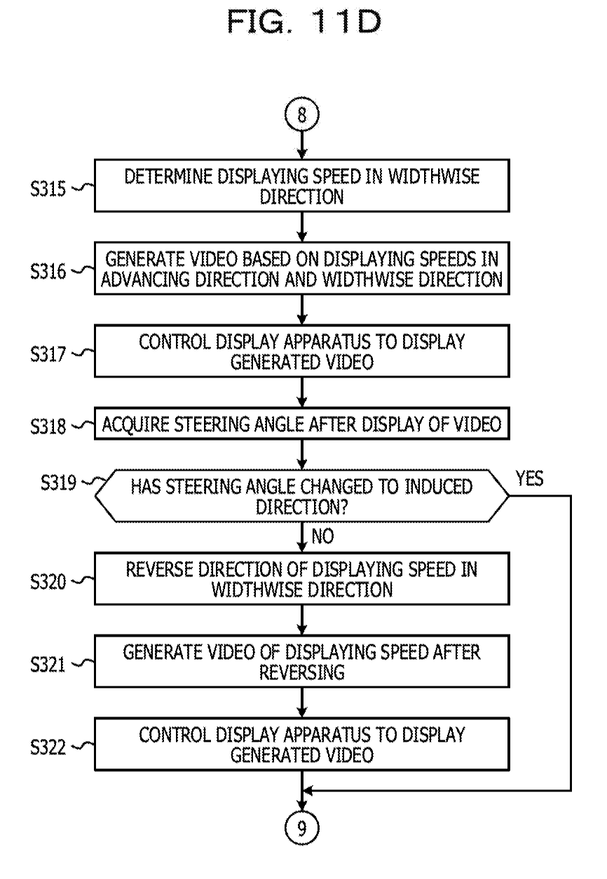

The video generation apparatus 3 according to the present embodiment repetitively executes a video displaying process illustrated in FIGS. 11A to 11D after every given interval of time while the driver 6 is driving the vehicle 1.

FIG. 11A is a flow chart (part 1) illustrating a video displaying process according to the third embodiment. FIG. 11B is a flow chart (part 2) illustrating the video displaying process according to the third embodiment. FIG. 11C is a flow chart (part 3) illustrating the video displaying process according to the third embodiment. FIG. 11D is a flow chart (part 4) illustrating the video displaying process according to the third embodiment.

The video generation apparatus 3 of the present embodiment first acquires a traveling speed of the vehicle 1 from the vehicle speed sensor 9 as depicted in FIG. 11A (step S301). The video generation apparatus 3 inputs the acquired traveling speed of the vehicle 1 to the video speed determination unit 304.

Then, in the video generation apparatus 3, the video speed determination unit 304 decides whether or not the vehicle 1 is traveling at an excessively high speed (step S302). The video speed determination unit 304 decides, for example, whether or not the acquired traveling speed of the vehicle is higher than a legal speed. For example, if the vehicle 1 is a passenger car and is traveling on an ordinary road, the video speed determination unit 304 decides at step S302 whether or not the traveling speed is higher than 60 kilometers per hour.

If the vehicle 1 is traveling at an excessively high speed (step S302: Yes), the video speed determination unit 304 determines the displaying speed of a picture for induction in the advancing direction to a speed of the induction to slow down to the value other than zero (step S303). If the vehicle 1 is traveling not at an excessively high speed (step S302: No), the video speed determination unit 304 determines the displaying speed of a picture for induction in the advancing direction to zero (step S304). For example, at steps S301 to S304, a moving speed of a picture for induction in the advancing direction in the video is determined based on the traveling speed of the vehicle 1 at present.

After step S303 or S304, the video generation apparatus 3 acquires data of an image including road surface ends from the image pickup apparatus 2 as depicted in FIG. 11B (step S305). The video generation apparatus 3 inputs the acquired image data to the road surface width detection unit 301.

Then, in the video generation apparatus 3, the road surface width detection unit 301 detects a road surface width of the road surface (lane) along which the vehicle 1 is traveling based on the acquired image data (step S306). The road surface width detection unit 301 extracts end portions of the road surface from the image data to detect the road surface width in accordance with a known road surface width detection method. The road surface width detection unit 301 transmits information relating to the detected road surface width to the vehicle position calculation unit 302.

Then, in the video generation apparatus 3, the vehicle position calculation unit 302 calculates the distance from the vehicle 1 to the road surface end (step S307). The vehicle position calculation unit 302 calculates the distance from the vehicle 1 to the road surface end based on the position of the road surface end in the image, the road surface width, and the width of the vehicle 1. At step S307, the vehicle position calculation unit 302 calculates, for example, the distance from the vehicle 1 to one of a road surface end at the left side of the vehicle 1 and another road surface end at the right side of the vehicle 1, which indicates a smaller distance from the vehicle 1. The vehicle position calculation unit 302 transmits information relating to the calculated distance from the vehicle 1 to the road surface end to the video speed determination unit 304.

Then, in the video generation apparatus 3, the steering angle acquisition unit 307 acquires a steering angle of the vehicle 1 at present (step S308). The steering angle acquisition unit 307 acquires information of a turn angle (steering angle) of the steering wheel at present from the steering sensor 8 incorporated in the vehicle 1. It is to be noted that the steering angle when the turn angle of the steering wheel is zero degrees, for example, when the vehicle 1 advances straightforwardly, is determined as zero degrees and the steering angle when the steering wheel is rotated in the clockwise direction as viewed from the driver 6 is determined to have a positive value. The steering angle acquisition unit 307 transmits information of the acquired steering angle to the video speed determination unit 304.

It is to be noted that the processes at steps S306 and S307 and the process at step S308 in FIG. 11B may be reverse in order. Alternatively, the processes at steps S306 and S307 and the process at step S308 may be performed in parallel. Further, the processes at steps S305 to S308 may be performed in parallel to the process at step S301 before step S302.

Then, in the video generation apparatus 3, the video speed determination unit 304 decides whether or not the driver 6 is steering (step S309). At step S309, the video speed determination unit 304 decides whether or not the direction of the steering angle is a direction in which the vehicle 1 is moved in the direction toward the road surface end nearer from the vehicle 1 and whether or not the absolute value of the steering angle is equal to or higher than the threshold value TH3. If the direction of the steering angle is a direction in which the vehicle 1 is moved in the direction toward the road surface end nearer from the vehicle 1 and besides the absolute value of the steering angle is equal to or higher than the threshold value TH3, the video speed determination unit 304 decides that the driver 6 is steering with such an intention to change the lane or the like. When the driver 6 is steering (step S309: Yes), the video speed determination unit 304 decides that a video for inducing the driver 6 is not to be displayed. In this case, the video speed determination unit 304 determines the displaying speed of a picture for induction in the widthwise direction to zero (step S310).

On the other hand, if the driver 6 is not steering (step S309: No), the video speed determination unit 304 subsequently decides whether or not the distance D2 from the road surface end nearer to the vehicle 1 to the vehicle 1 is equal to or smaller than the threshold value TH2 (step S311). If D2≦TH2 (step S311: Yes), the video speed determination unit 304 subsequently performs the process at step S315 illustrated in FIG. 11D. If D>TH2 (step S311: No), the video speed determination unit 304 subsequently determines the displaying speed of a picture for induction in the widthwise direction to zero (step S310).

After step S310, the video speed determination unit 304 checks whether or not the displaying speed of a picture for induction in the advancing direction is zero as illustrated in FIG. 11C (step S312). If the displaying speed in the advancing direction is zero, the displaying speed (moving speed) for a picture for induction in the video is zero in regard to both of the advancing direction and the widthwise direction. Therefore, when the displaying speed of a picture for induction in the advancing direction is zero (step S312: Yes), the video speed determination unit 304 decides that a video for inducing the driver 6 is not to be displayed. In this case, the video generation apparatus 3 ends the video displaying process omitting the processes at steps S313 and S314 as illustrated in FIG. 11C and starts a next video displaying process.

On the other hand, if the displaying speed of a picture for induction in the advancing direction is not zero, the video speed determination unit 304 transmits the displaying speed of a picture for induction to the video generation unit 305. For example, when the displaying speed of a picture for induction in the advancing direction is not zero (step S312: No), in the video generation apparatus 3, the video generation unit 305 subsequently generates a video for inducing the driver 6 to slow down based on the displaying speed in the advancing direction (step S313). The video generation unit 305 transmits the generated video to the display controller 306.

Thereafter, in the video generation apparatus 3, the display controller 306 causes the display apparatus 4 to display the video generated by the video generation unit 305 (step S314). After the process at step S314 comes to an end, the video generation apparatus 3 ends the video displaying process in the present cycle and starts a video displaying process in a next cycle.

In this manner, when the driver 6 is steering with such an intention as to change the lane or the like, or when the distance D2 from a road surface end nearer to the vehicle 1 to the vehicle 1 is greater than the threshold value TH2, the video generation apparatus 3 determines the displaying speed of a picture for induction in the widthwise direction to zero. Therefore, when the driver 6 is operating the steering wheel, or when the distance D2 is greater than the threshold value TH2, only when the vehicle 1 is traveling at an excessively high speed, the video generation apparatus 3 generates a video for inducing the driver 6 to slow down and causes the display apparatus 4 to display the video. In this case, the video generation apparatus 3 generates a video in which, for example, the picture for induction moves in a direction opposite to the advancing direction of the vehicle 1 and causes the display apparatus 4 to display the video.

On the other hand, if the driver 6 is not steering and besides the distance D2 from a road surface end nearer to the vehicle 1 to the vehicle 1 is equal to or smaller than the threshold value TH2, the video generation apparatus 3 (video speed determination unit 304) performs the processes at steps beginning with step S315 depicted in FIG. 11D. At step S315, the video speed determination unit 304 determines a displaying speed (moving speed) for a picture for induction in the widthwise direction. After the displaying speed in the widthwise direction is determined, the video speed determination unit 304 transmits the determined displaying speeds in the advancing direction and the widthwise direction to the video generation unit 305.

Then, in the video generation apparatus 3, the video generation unit 305 generates a video including a picture for induction based on the displaying speeds in the advancing direction and the widthwise direction determined by the video speed determination unit 304 (step S316). The video generation unit 305 transmits the generated video to the display controller 306.

Then, in the video generation apparatus 3, the display controller 306 causes the display apparatus 4 to display the video generated by the video generation unit 305 (step S317). At this time, the display controller 306 notifies the video speed determination unit 304 that the video is displayed on the display apparatus 4.

After the process at step S317 comes to an end, the video speed determination unit 304 of the video generation apparatus 3 subsequently acquires a steering angle after the display of the video through the steering angle acquisition unit 307 (step S318) and decides whether or not the steering angle has changed to the induced direction (step S319). At step S319, the video speed determination unit 304 reads out the steering angle before the display of the video from the storage unit 310 and compares the read out steering angle with the steering angle after the display of the video to decide whether or not the steering angle has changed to the induced direction. If the steering angle has changed to the induced direction (step S319: Yes), the video speed determination unit 304 decides that the speed of a picture for induction is not to be corrected. In this case, the video generation apparatus 3 ends the video displaying process omitting the processes at steps S320 to S322 as illustrated in FIGS. 11D and 11B and starts a next video displaying process.

On the other hand, if the steering angle has not changed to the induced direction (step S319: No), the video speed determination unit 304 performs correction for reversing the direction of the displaying speed of a picture for induction (step S320). At step S320, the video speed determination unit 304 reverses the direction of one or both of the displaying speeds for a picture for induction in the advancing direction and the widthwise direction to correct the moving direction for a picture for induction. After the correction for reversing the displaying speeds, the video speed determination unit 304 transmits the displaying speeds after the correction to the video generation unit 305.

Then, in the video generation apparatus 3, the video generation unit 305 generates a video for inducing the driver 6 based on the displaying speeds after the reversing (step S321). The video generation unit 305 transmits the generated video to the display controller 306.

Then, in the video generation apparatus 3, the display controller 306 causes the display apparatus 4 to display the video generated by the video generation unit 305 (step S322). After the process at step S322 comes to an end, the video generation apparatus 3 ends the video displaying process in the present cycle and starts a video displaying process in the next cycle.

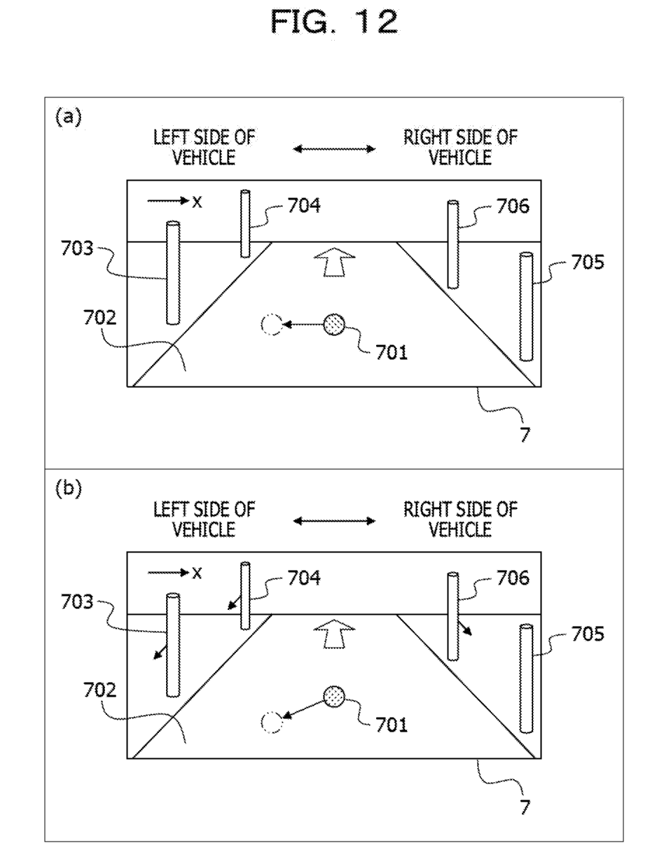

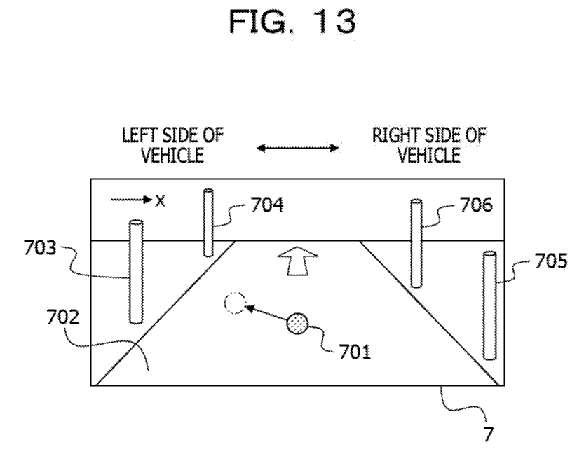

FIG. 12 is a view depicting an example of a video displayed by a video displaying process according to the third embodiment. FIG. 13 is a view depicting another example of a video displayed by a video displaying process according to the third embodiment.

In the video displaying process according to the present embodiment, when the vehicle 1 is traveling not at an excessively high speed, the video generation apparatus 3 determines the displaying speed of a picture for induction in the advancing direction to zero (step S304). Therefore, when the traveling situation of the vehicle 1 satisfies the following conditions 1 to 3, the video displayed on the display apparatus 4 becomes a video in which the picture 701 for induction in the video 7 moves in parallel to the widthwise direction as illustrated in (a) of FIG. 12.
(Condition 1) The vehicle 1 is traveling not at an excessively high speed.
(Condition 2) The absolute value of the steering angle is smaller than the threshold value TH3.
(Condition 3) The distance D2 between a road surface end nearer to the vehicle 1 and the vehicle 1 is equal to or smaller than the threshold value TH2.

On the other hand, if the vehicle 1 is traveling at an excessively high speed and the (condition 1) described above is not satisfied, the video generation apparatus 3 determines the displaying speed of a picture for induction in the advancing direction to a value other than zero (step S303). In this case, the video generation apparatus 3 generates a video for inducing the driver 6 to slow down and causes the display apparatus 4 to display the generated video. Therefore, the video generation apparatus 3 (video speed determination unit 304) generates a video in which the picture 701 for induction in the video 7 moves in the widthwise direction while moving to the near side in the advancing direction and causes the display apparatus 4 to display the generated video as illustrated in (b) of FIG. 12, for example. When the video in which the picture 701 for induction moves in the widthwise direction is displayed, the driver 6 tends to steer the vehicle 1 so as to move the vehicle 1 in the moving direction of the picture 701 due to a vection occurring in the driver 6 as described in connection with the first embodiment. Further, when the picture 701 for induction moves to the near side in the advancing direction, the driver 6 tends to have a sensation (vection) that the speed of the vehicle 1 has increased and the distance to the object in front (picture 701) has decreased. Therefore, when the picture 701 for induction moves to the near side in the advancing direction, the driver 6 tends to slow down such that the distance to the object in front increases. Consequently, when only the (condition 2) and the (condition 3) described above are satisfied, by displaying a video in which the picture 701 for induction in the video 7 moves in the widthwise direction while moving to the near side in the advancing direction, it may be possible to induce the driver 6 to perform steering and slowing down.

It is to be noted that there are individual differences in vection that occurs in the driver 6 when the picture 701 for induction moves in the advancing direction, and depending upon the driver 6, a vection reverse to that described hereinabove may occur. For example, when a video in which the picture 701 moves to the left side of the video 7 while moving to the near side in the advancing direction is displayed, depending upon the driver 6, the vehicle 1 may be steered so as to move in the rightward direction. Therefore, when a video generated based on the displaying speed in the widthwise direction determined at step S315 is displayed, if the video fails to induce the driver 6 to steer in the correct direction (step S319: No), the video generation apparatus 3 reverses the displaying speed of the picture 701 (step S320).

When the displaying speed of the picture 701 for induction is reversed, for example, the moving direction in the advancing direction may be reversed as depicted in FIG. 13 in place of reversing the moving direction of the picture 701 in the widthwise direction to the opposite direction. Further, although the process illustrated in FIG. 11D includes the process for reversing the displaying speed only once, the speeds of the picture 701 for induction in the advancing direction and the widthwise direction may be successively reversed until the driver 6 performs steering and slowing down correctly.

As described above, according to the present embodiment, when the distance between a vehicle and a road surface end is excessively small, it may be possible to induce the driver of the vehicle to steer making use of a video such that the distance between the vehicle and the road surface end increases. Therefore, when there is the possibility that the vehicle may depart from a lane along which the vehicle is traveling, it may be possible to utilize the sense of sight to induce the driver to steer so as to maintain the lane.

Further, by providing a component of a speed in the advancing direction to a moving speed (displaying speed) of a picture 701 in the video in response to the traveling speed of the vehicle 1, also it may be possible to induce the driver to slow down the vehicle 1.

Further, since the driver is induced to steer by displaying a video that causes the driver to have a vection as described hereinabove, it may be possible to induce the driver to steer naturally in comparison with an alternative case in which the driver is induced by alarming sound. Further, since it is possible to induce the driver without generating alarming sound, it may be possible to induce the driver without giving a discomfort to the driver or another passenger.

Further, where the driver is induced to perform two different operations for steering and slowing down using alarming sound, in order to make it clear to distinguish the types of operations for induction, such countermeasures as to change the type of alarming sound in response to the type of the operation may be demanded. Therefore, it may be demanded to comprehend the corresponding relationship between the alarming sounds and the operations, and increase in type of operations for induction increases the burden on the driver. In contrast, in the present embodiment, since a video that causes the driver to have a vection is displayed to induce the driver to naturally perform steering or slowing down, it may be possible to induce the driver to perform safe driving without imposing a burden on the driver.

It is to be noted that the processes illustrated in FIGS. 11A to 11D are a mere example of the video displaying process according to the present embodiment. The video displaying process according to the present embodiment may be a process that includes a process for displaying a video that induces the driver to steer based on the distance between a moving object (another vehicle) that approaches an own vehicle from the rear and the own vehicle as in the case of the first embodiment. Where the video displaying process includes a process for displaying a video that induces the driver to steer based on the distance between a moving object (another vehicle) that approaches an own vehicle and the own vehicle as in the case of the first embodiment, the video generation apparatus 3 includes the object detection unit 303.

### Fourth Embodiment

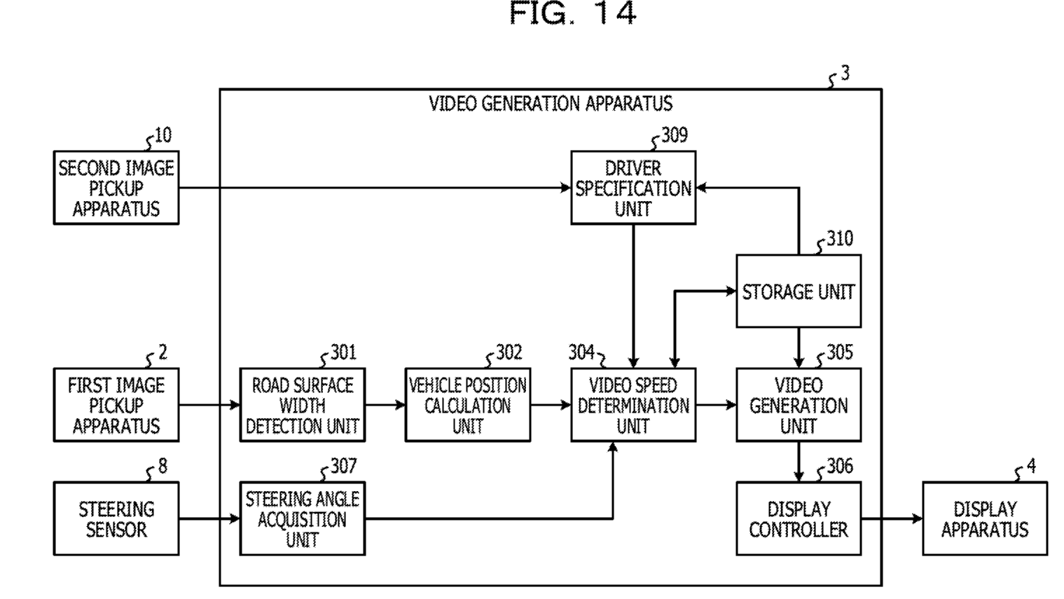

FIG. 14 is a block diagram depicting a functional configuration of a video generation apparatus according to a fourth embodiment.

The video generation apparatus 3 according to the present embodiment is incorporated as a component of an induction system in a vehicle 1 similarly to the video generation apparatus 3 according to the first embodiment.

As depicted in FIG. 14, the video generation apparatus 3 according to the present embodiment includes a road surface width detection unit 301, a vehicle position calculation unit 302, a video speed determination unit 304, a video generation unit 305, a display controller 306, a steering angle acquisition unit 307, a driver specification unit 309, and a storage unit 310. Further, the induction system that includes the video generation apparatus 3 according to the present embodiment includes, as depicted in FIG. 14, a first image pickup apparatus 2 for picking up an image including a road surface and an object on the road surface, and an second image pickup apparatus 10 for picking up an image including the face of a driver.

The road surface width detection unit 301 detects end portions in the widthwise direction of the road surface (lane) along which the vehicle 1 is travelling, based on an image picked up by the first image pickup apparatus 2.

The vehicle position calculation unit 302 calculates the distances from the vehicle 1 to the road surface ends as the position of the vehicle 1 in the widthwise direction of the lane.

The video generation unit 305 and the display controller 306 are same as the video generation unit 305 and the display controller 306 in the first embodiment.

The video speed determination unit 304 determines a moving speed (displaying speed) of a picture for induction in a video displayed on a display apparatus 4 based on the position of the vehicle 1 in the widthwise direction, a steering angle, and information relating to a vection of the driver. The video speed determination unit 304 acquires the position of the vehicle 1 in the widthwise direction from the vehicle position calculation unit 302 and acquires a steering angle from the steering angle acquisition unit 307. Further, the video speed determination unit 304 acquires information that specifies the driver from the driver specification unit 309. It is to be noted that the video speed determination unit 304 in the present embodiment determines a speed of a picture for induction in a video displayed on the display apparatus 4 when the distance between one of the road surface ends which is nearer from the vehicle 1 and the vehicle 1 is equal to or smaller than a threshold value TH2 and besides the steering angle is smaller than a threshold value TH3. When a speed of a picture for induction is determined, the video speed determination unit 304 determines a speed of a picture for induction in the widthwise direction based on the position of the vehicle 1 in the widthwise direction and determines whether or not the direction of the speed is to be reversed based on the driver information.

The steering angle acquisition unit 307 acquires a steering angle, for example, information relating to a turn angle of the steering wheel of the vehicle 1, from a steering sensor 8 incorporated in the vehicle 1.

The driver specification unit 309 specifies the driver based on an image picked up by the second image pickup apparatus 10 and driver information stored in the storage unit 310. Further, if the driver specification unit 309 fails to specify the driver from an image picked up by the second image pickup apparatus 10, the driver specification unit 309 learns a tendency of the vection relating to the driver at present to generate new driver information and causes the storage unit 310 to store the new driver information.

Into the storage unit 310, data that is a source of a video generated and including data of a picture for induction, information of the steering angle when a speed of a picture for induction is determined, driver information and so forth are stored.

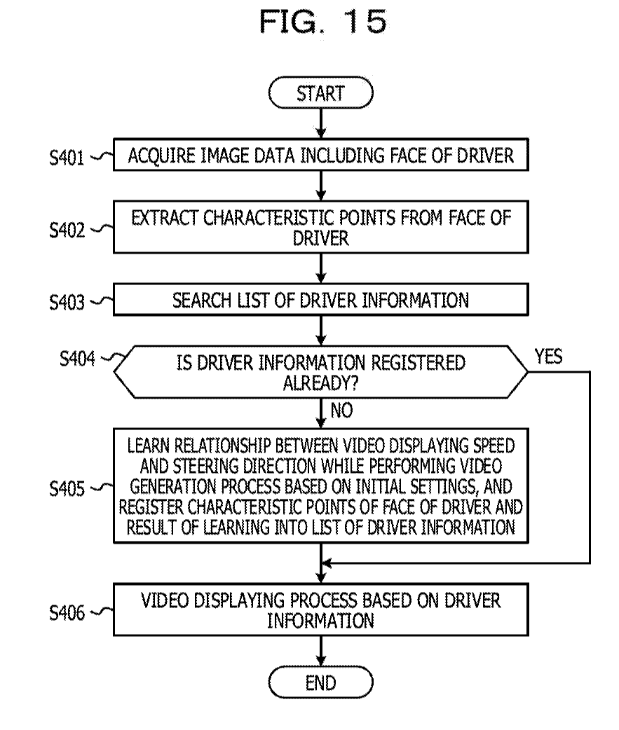

The video generation apparatus 3 in the induction system according to the present embodiment executes a process illustrated in FIG. 15 when the driver 6 starts driving of the vehicle 1.

FIG. 15 is a flow chart illustrating processes performed by a video generation apparatus according to the fourth embodiment.

The video generation apparatus 3 of the present embodiment first acquires, as depicted in FIG. 15, data of an image picked up by the second image pickup apparatus 10 and including the face of the driver (step S401). The process at step S401 is performed by the driver specification unit 309. After the driver specification unit 309 acquires the data of the image including the face of the driver, the driver specification unit 309 performs processes at steps S402 to S405. For example, the driver specification unit 309 subsequently extracts characteristic points of the face of the driver from the acquired image (step S402).

Then, the driver specification unit 309 searches a list of driver information stored in the storage unit 310 using the extracted characteristic points as key information (step S403) and decides whether or not the driver information of the driver at present is registered already (step S404). If the driver information of the driver at present is registered already (step S404: Yes), the driver specification unit 309 transmits the driver information in question to the video speed determination unit 304. Thereafter, the video generation apparatus 3 performs a video displaying process based on the driver information (step S406).

On the other hand, if the driver information of the driver at present is not registered as yet (step S404: No), the driver specification unit 309 transmits to the video speed determination unit 304 that the driver information is not registered as yet. In this case, the video generation apparatus 3 learns a relationship between the displaying speed of the video and the steering direction while performing a video generation process based on initial settings and registers the characteristic points of the face of the driver and a result of the learning into the list of driver information (step S405). At step S405, the video generation apparatus 3 performs, for example, the video displaying process according to the second embodiment (refer to FIGS. 9A and 9B) and learns a relationship between the moving direction of a picture for induction and steering directions of the driver before and after the display of the video. For example, the video generation apparatus 3 learns whether or not the video speed determination unit 304 has performed the processes at steps S212 to S214 (correction for reversing the moving direction of a picture for induction). After the learning comes to an end, the video speed determination unit 304 transmits a result of the learning (for example, whether or not correction for reversing the moving direction of a picture for induction has been performed) to the driver specification unit 309. The driver specification unit 309 receives the result of the learning, and then registers the characteristic points of the face of the driver extracted at step S402 and the result of the learning in an associated relationship with each other into the list of the driver information of the storage unit 310. Thereafter, the video generation apparatus 3 performs a video displaying process (step S406) based on the driver information.

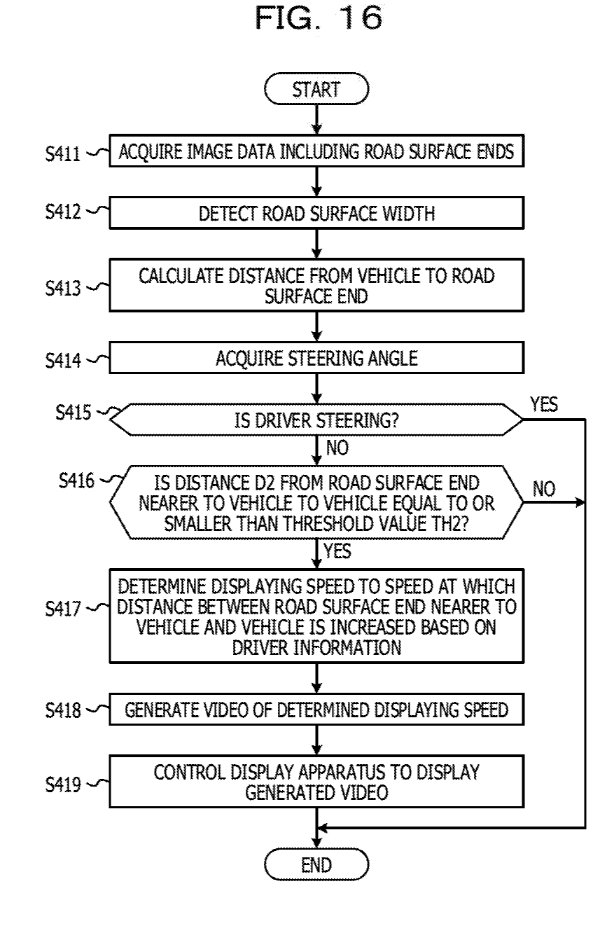

The video generation apparatus 3 of the present embodiment executes a video displaying process depicted in FIG. 16 as the video displaying process (step S406) based on the driver information after the processes at steps S401 to S405. It is to be noted that the video generation apparatus 3 executes the video displaying process illustrated in FIG. 16 repetitively after every given time interval while the one driver 6 is driving the vehicle 1.

FIG. 16 is a flow chart illustrating contents of a video displaying process based on driver information.

In the video displaying process (step S406) based on driver information, the video generation apparatus 3 first acquires, as depicted in FIG. 16, data of an image picked up by the first image pickup apparatus 2 and including road surface ends (step S411). The video generation apparatus 3 inputs the acquired image data to the road surface width detection unit 301.

Then, in the video generation apparatus 3, the road surface width detection unit 301 detects a road surface width of the road surface (lane) along which the vehicle 1 is traveling, based on the acquired image data (step S412). The road surface width detection unit 301 extracts end portions of the road surface from the image data in accordance with a known road surface width detection method and detects the road surface width. The road surface width detection unit 301 transmits information of the detected road surface width to the vehicle position calculation unit 302.

Then, in the video generation apparatus 3, the vehicle position calculation unit 302 calculates a distance from the vehicle 1 to a road surface end (step S413). The vehicle position calculation unit 302 calculates the distance from the vehicle 1 to a road surface end based on the position of the road surface end in the image, the road surface width, and the width of the vehicle 1. At step S413, the vehicle position calculation unit 302 calculates, for example, the distance from the vehicle 1 to one of a load surface end at the left side of the vehicle 1 and another load surface end at the right side of the vehicle 1, which indicates a smaller distance from the vehicle 1. The vehicle position calculation unit 302 transmits information relating to the calculated distance from the vehicle 1 to the road surface end to the video speed determination unit 304.

Then, in the video generation apparatus 3, the steering angle acquisition unit 307 acquires the steering angle at present of the vehicle 1 (step S414). The steering angle acquisition unit 307 acquires information of a turn angle (steering angle) of the steering wheel at present from the steering sensor 8 incorporated in the vehicle 1. It is to be noted that the steering angle when the turn angle of the steering wheel is zero degrees, for example, when the vehicle 1 advances straightforwardly, is determined as zero degrees and the steering angle when the steering wheel is rotated in the clockwise direction as viewed from the driver 6 is determined to have a positive value. The steering angle acquisition unit 307 transmits information of the acquired steering angle to the video speed determination unit 304.

It is to be noted that the processes at steps S411 to S413 and the process at step S414 in FIG. 16 may be reversed in order. Alternatively, the processes at steps S411 to S413 and the process at step S414 may be performed in parallel.

Then, in the video generation apparatus 3, the video speed determination unit 304 decides whether or not the driver 6 is steering (step S415). At step S415, the video speed determination unit 304 performs a decision of whether or not the direction of the steering angle is a direction in which the vehicle 1 is to be moved in a direction toward the road surface end nearer from the vehicle 1 and another decision of whether or not the absolute value of the steering angle is equal to or higher than the threshold value TH3. If the direction of the steering angle is a direction in which the vehicle 1 is to be moved in a direction toward the road surface end nearer from the vehicle 1 and besides the absolute value of the steering angle is equal to or higher than the threshold value TH3, the video speed determination unit 304 decides that the driver 6 is steering with an intention to change the lane or the like. If the driver 6 is steering (step S415: Yes), the video speed determination unit 304 decides that a video for inducing the driver 6 is not to be displayed. In this case, the video generation apparatus 3 ends the video displaying process as depicted in FIG. 16 and starts a next video displaying process.

On the other hand, if the driver 6 is not steering (step S415: No), the video speed determination unit 304 subsequently decides whether or not a distance D2 from the road surface end nearer to the vehicle 1 to the vehicle 1 is equal to or smaller than the threshold value TH2 (step S416). If D2>TH2 (step S416: No), the video speed determination unit 304 decides that a video for inducing the driver 6 is not to be displayed. In this case, the video generation apparatus 3 ends the video displaying process as depicted in FIG. 16 and starts a next video displaying process.

On the other hand, if D2≦TH2 (step S416: Yes), the video speed determination unit 304 determines the displaying speed of a picture for induction to a speed at which the distance between the road surface end nearer to the vehicle 1 and the vehicle 1 is increased based on the driver information (step S417). At step S417, the video speed determination unit 304 first determines a speed of a picture for induction in a video displayed based on initial settings. Then, if the relationship between the moving direction of a picture for induction and the steering direction of the driver 6 in the driver information is opposite to the relationship in the initial settings, the video speed determination unit 304 reverses the direction of the displaying speed (moving speed) for a picture for induction. When the process at step S417 comes to an end, the video speed determination unit 304 transmits the determined displaying speed to the video generation unit 305. Further, the video speed determination unit 304 causes the storage unit 310 to store the steering angle at present.

Then, in the video generation apparatus 3, the video generation unit 305 generates a video of the displaying speed determined by the video speed determination unit 304 (step S418). The video generation unit 305 reads out data that is a source of a video generated and including data of a picture for induction from the storage unit 310 and generates a video. The video generation unit 305 transmits the generated video to the display controller 306.

Finally, in the video generation apparatus 3, the display controller 306 causes the display apparatus 4 to display the video generated by the video generation unit 305 (step S419). After the process at step S419 comes to an end, the video generation apparatus 3 starts a next video displaying process.

In this manner, in the video displaying process according to the present embodiment, a steering direction of a driver when a picture for induction is displayed at a speed determined based on initial settings is learned and registered into a list of driver information. Therefore, when a driver registered in the list is driving a vehicle, it may be possible to generate, based on the driver information, and display a video in which a picture for induction moves in a direction in which the driver is able to be induced to steer in a correct direction. Therefore, the video displaying process of the present embodiment may not involve a process for deciding, after the video for inducing the driver is displayed, whether or not the driver has been induced correctly in regard to the steering direction of the driver every time and correcting, if the driver has been induced to steer in a wrong direction, the speed. Accordingly, with the present embodiment, it may be possible to reduce the processing load on the video generation apparatus 3.

It is to be noted that the processes depicted in FIG. 15 are a mere example of processes executed by the video generation apparatus 3 according to the present embodiment and contents of the process and so forth are suitably alterable. The process for specifying the driver 6 may be, for example, a process for causing a driver to operate an inputting apparatus not depicted in FIG. 14 to input information for specifying the driver himself/herself and specifying the driver.

Further, the processes illustrated in FIG. 16 are a mere example of the video displaying process based on driver information. The video displaying process according to the present embodiment may be a process that includes a process for displaying a video for inducing a driver to steer based on the distance between a moving object (another vehicle) that approaches an own vehicle from the rear and the own vehicle as in the first embodiment. Where the video displaying process includes a process for displaying a video for inducing a driver to steer based on the distance between a moving object (another vehicle) that approaches an own vehicle from the rear and the own vehicle as in the first embodiment, the video generation apparatus 3 includes the object detection unit 303.

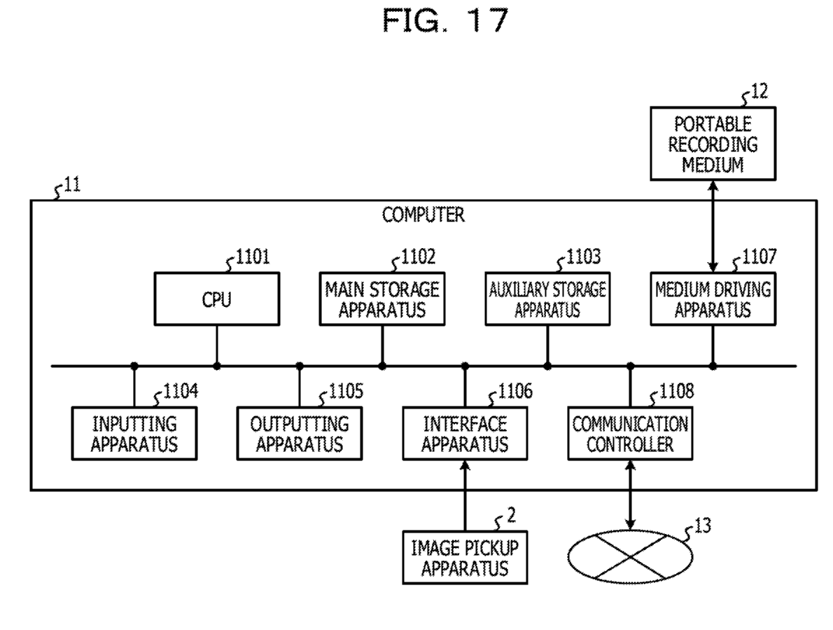

In the video generation apparatus 3 according to any one of the first to fourth embodiments, it may be implemented using a computer and a program executed by the computer. In the following, the video generation apparatus 3 implemented using a computer and a program is described with reference to FIG. 17.

FIG. 17 is a view depicting a hardware configuration of a computer.

As depicted in FIG. 17, the computer 11 includes a central processing unit (CPU) 1101, a main storage apparatus 1102, an auxiliary storage apparatus 1103, an inputting apparatus 1104, and an outputting apparatus 1105. The computer 11 further includes an interface apparatus 1106, a medium driving apparatus 1107, and a communication controller 1108. The components 1101 to 1108 of the computer 11 are coupled with each other by a bus 1110 such that data may be transferred between the components.

The CPU 1101 is an arithmetic processing unit that controls entire operation of the computer 11 by executing various programs including an operating system.

The main storage apparatus 1102 includes a read only memory (ROM) and a random access memory (RAM) not depicted. In the ROM of the main storage apparatus 1102, for example, a given basic controlling program and the like read out by the CPU 1101 upon activation of the computer 11 are recorded in advance. Meanwhile, the RAM of the main storage apparatus 1102 is used as a working storage area as occasion demands when the CPU 1101 executes the various programs. The RAM of the main storage apparatus 1102 may be used to store, for example, data of an image picked up by the image pickup apparatus 2, the position of the vehicle 1 in the widthwise direction, various threshold values and so forth.

The auxiliary storage apparatus 1103 is a storage device having a storage capacity greater than a storage capacity of the main storage apparatus 1102 such as a solid state drive (SSD). Into the auxiliary storage apparatus 1103, various programs executed by the CPU 1101, various data and so forth may be stored. The auxiliary storage apparatus 1103 may be utilized to store, for example, a program including any of the video displaying processes used in the first to fourth embodiments. Further, the auxiliary storage apparatus 1103 may be utilized to store, for example, data of an image picked up by the image pickup apparatus 2, data that is a source of a video including a picture for induction and so forth. Further, the auxiliary storage apparatus 1103 may be utilized for storage of a display history of videos including pictures for induction. It is to be noted that, where the computer 11 incorporates a hard disk drive (HDD) coupled with the bus 1110, the HDD in question may be utilized as the auxiliary storage apparatus 1103.

The inputting apparatus 1104 is, for example, a keyboard device or a button switch. If an operator of the computer 11 (a driver or the like) performs such an operation as to depress the inputting apparatus 1104, the inputting apparatus 1104 transmits input information associated with contents of the operation to the CPU 1101.

The outputting apparatus 1105 is, for example, a liquid crystal display unit, a pilot lamp, a speaker or the like. The outputting apparatus 1105 is used to display a video including a picture for induction, to confirm an operation state of the computer 11 and so forth. The outputting apparatus 1105 may otherwise be a head-up display unit.

The interface apparatus 1106 is an apparatus for coupling the computer 11 with another electronic apparatus or the like, and includes a connector compatible with the universal serial bus (USB) standard, a connector standard for a wire harness for a vehicle or the like. Apparatus that is able to be coupled with the computer 11 by the interface apparatus 1106 may be, for example, the display apparatus 4 such as a head-mounted display unit not depicted, and various electronic controlling units (ECUs) incorporated in the vehicle 1 as well as the image pickup apparatus 2 illustrated in FIG. 17.

The medium driving apparatus 1107 performs reading out of a program or data recorded on a portable recording medium 12 and writing of data or the like stored in the auxiliary storage apparatus 1103 on the portable recording medium 12. As the portable recording medium 12, for example, a flash memory equipped with a connector of the USB standard, a memory card of the secure digital (SD) standard and so forth may be utilized. Further, where the computer 11 incorporates an optical disk drive as the medium driving apparatus 1107, optical disks such as a compact disk (CD), a digital versatile disc (DVD), and a Blu-ray disc (Blu-ray is a registered trademark) may be utilized as the portable recording medium 12. The portable recording medium 12 may be utilized for provision or the like of a program including any of the video displaying processes used in the first to fourth embodiments.

The communication controller 1108 is an apparatus that couples the computer 11 and a communication network 13 such as the Internet for communication and controls various types of communication between the computer 11 and another communication terminal not depicted through the communication network 13. By causing the computer 11 including the communication controller 1108 to operate as the video generation apparatus 3, it may be possible, for example, to transmit a display history (induction history) of videos stored in the auxiliary storage apparatus 1103 and including pictures for induction to a given server. Where induction histories accumulated in a plurality of computers 11 may be managed collectively by the server, it may be possible to perform, for example, safe driving evaluation, driving guidance and so forth of each driver in a transporting company or the like using the induction history.

In the computer 11, the CPU 1101 reads out a program including one of the video displaying processes used in each of the embodiments from the auxiliary storage apparatus 1103 or the like and executes the program to generate a video for inducing a driver to steer or slow down and cause a display apparatus to display the video. Along with this, the CPU 1101 in the computer 11 operates as the road surface width detection unit 301, the vehicle position calculation unit 302, the video speed determination unit 304, the video generation unit 305, the display controller 306 and so forth in the video generation apparatus 3 depicted in FIG. 2 or the like. Further, the RAM of the main storage apparatus 1102 or the auxiliary storage apparatus 1103 in the computer 11 functions as the storage unit 310 in the video generation apparatus 3 depicted in FIG. 2 or the like.

It is to be noted that the computer 11 that operates as the video generation apparatus 3 may not include all of the components depicted in FIG. 17. Some components may be omitted in accordance with an application or a condition. For example, the computer 11 may be a vehicle-carried ECU or may be, where it is installed at a place at which it is difficult for the driver to operate the computer 11 during driving, a computer from which the medium driving apparatus 1107 is omitted. Further, where safe driving evaluation or the like in which an induction history is utilized is not performed, the computer 11 may be configured such that the communication controller 1108 is omitted therefrom.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention. For example, the steps recited in any of the method or process descriptions may be executed in any order and are not limited to the order presented.

What is claimed is:

1. An apparatus for video generation, the apparatus comprising:
a memory; and
a processor coupled to the memory and configured to
execute a road surface end detection process to detect, from an image including a road surface along which a vehicle travels, a road surface end of the road surface in a widthwise direction,
execute a calculation process to calculate a distance from the vehicle to the road surface end,
execute a generation process to generate, when the calculated distance is smaller than a given threshold value, a video for inducing a driver of the vehicle to steer to a direction in which the distance increases, and
execute a display control process to cause a display apparatus to display the generated video.

2. The apparatus according to claim 1,
wherein the processor is configured to
execute an object detection process to detect a moving object approaching the vehicle from an opposite direction to an advancing direction of the vehicle, and calculate a position of the moving object in the widthwise direction, and
wherein, in the generation process, the processor is configured to, when a distance from the vehicle to the moving object in the widthwise direction is smaller than a given threshold value, generate a video for inducing the driver of the vehicle to steer to a direction in which the distance from the vehicle to the moving object increases.

3. The apparatus according to claim 1,
wherein, in the generation process, the processor is configured to generate the video including a picture that moves in the widthwise direction of the road surface.

4. The apparatus according to claim 3,
wherein the processor is configured to execute a speed determination process to determine, when the calculated distance is smaller than a given threshold value, a moving speed of the picture, and
wherein, in the generation process, the processor is configured to generate the video in which the picture moves at the determined moving speed.

5. The apparatus according to claim 4,
wherein, in the speed determination process, the processor is configured to, when the vehicle does not move in the direction in which the distance from the vehicle to the road surface end increases after the video including the picture that moves at the determined moving speed is displayed, reverse a moving direction of the picture.

6. The apparatus according to claim 5,
wherein the processor is configured to execute a steering angle acquisition process to acquire a steering angle of the vehicle, and
wherein, in the speed determination process, the processor is configured to decide whether or not the vehicle has moved in the direction in which the distance from the vehicle to the road surface end increases based in part on the steering angle of the vehicle after the video is displayed.

7. The apparatus according to claim 6,
wherein, in the speed determination process, the processor is configured to
decide whether or not the driver of the vehicle is steering the vehicle in a direction toward the road surface end based in part on the direction of the road surface end as viewed from the vehicle and the steering angle of the vehicle, and
set, when the driver of the vehicle is steering the vehicle in the direction toward the road surface end, the moving speed of the picture in the widthwise direction to zero.

8. The apparatus according to claim 6,
wherein the processor is configured to execute a speed acquisition process to acquire a speed of the vehicle, and
wherein, in the speed determination process, the processor is configured to
determine, when the speed of the vehicle exceeds a given threshold value, the moving speed of the picture in the vehicle advancing direction to a value other than zero, and
generate the video in which the picture moves in the advancing direction of the vehicle.

9. The apparatus according to claim 3,
wherein the processor is configured to execute a driver specification process to specify the driver of the vehicle,
wherein the memory is configured to store a list in which the moving direction of the picture when the video in which the picture moves in a given direction is displayed and a steering direction of the vehicle by the driver are associated with each other, and
wherein, in the speed determination process, the processor is configured to determine the moving direction of the picture based on the list.

10. A method, executed by a computer, for video generation, the method comprising:
executing a road surface end detection process to detect, from an image including a road surface along which a vehicle travels, a road surface end of the road surface in a widthwise direction;
executing a calculation process to calculate a distance from the vehicle to the road surface end;
executing a generation process to generate, when the calculated distance is smaller than a given threshold value, a video for inducing a driver of the vehicle to steer to a direction in which the distance increases; and
executing a display control process to cause a display apparatus to display the generated video.

11. The method according to claim 10, the method further comprising:
executing an object detection process to detect a moving object approaching the vehicle from an opposite direction to an advancing direction of the vehicle and calculating a position of the moving object in the widthwise direction,
wherein the generation process includes generating, when a distance from the vehicle to the moving object in the widthwise direction is smaller than a given threshold value, a video for inducing the driver of the vehicle to steer to a direction in which the distance from the vehicle to the moving object increases.

12. The method according to claim 10,
wherein, in the generation process, the processor is configured to generate the video including a picture that moves in the widthwise direction of the road surface.

13. A non-transitory computer-readable storage medium storing a program that causes a computer to execute a process, the process comprising:
executing a road surface end detection process to detect, from an image including a road surface along which a vehicle travels, a road surface end of the road surface in a widthwise direction;
executing a calculation process to calculate a distance from the vehicle to the road surface end;
executing a generation process to generate, when the calculated distance is smaller than a given threshold value, a video for inducing a driver of the vehicle to steer to a direction in which the distance increases; and
executing a display control process to cause a display apparatus to display the generated video.

14. The storage medium according to claim 13, the process further comprising:
executing an object detection process to detect a moving object approaching the vehicle from an opposite direction to an advancing direction of the vehicle and calculating a position of the moving object in the widthwise direction,
wherein the generation process includes generating, when a distance from the vehicle to the moving object in the widthwise direction is smaller than a given threshold value, a video for inducing the driver of the vehicle to steer to a direction in which the distance from the vehicle to the moving object increases.

15. The storage medium according to claim 13,
wherein the generation process includes generating the video including a picture that moves in the widthwise direction of the road surface.
